(19) United States
(12) Patent Application Publication
(10) Pub. No.: US 2009/0276318 A1
(43) Pub. Date: Nov. 5, 2009

(54) Nagivation Provision System and Framework for Providing Content to an End User

(75) Inventors: Matthew John Broadbent, Bronx, NY (US); Benjamin Peter Bodley, Christchurch (NZ)

Correspondence Address: VEDDER PRICE P.C., 222 N. LASALLE STREET, CHICAGO, IL, 60601, US

(73) Assignee: MITAC INTERNATIONAL CORP., Kuei-Shand Hsiang, Tao-Yuan Hsien (TW)

(21) Appl. No.: 12/297,690

(22) PCT Filed: Apr. 20, 2007
(86) PCT No.: PCT/NZ07/00085

§ 371 Date: Feb. 19, 2009

(30) Foreign Application Priority Data
Apr. 20, 2006 (SG) 200602670-2

(51) Int. Cl. G01C 21/36; G06F 15/16; G06F 9/445; G06F 9/46; G06F 3/048; G06Q 30/00

(52) U.S. Cl. 705/14.64; 709/203; 717/177; 718/1; 715/810; 701/207; 701/200

(57) ABSTRACT

The invention relates to navigation devices and to the provision of both data and functionality to navigation devices. The invention provides a navigation device running basic navigation framework software, supporting a complete navigation content provision framework, wherein the framework can support a fixed set of plug-in software object types. The supported plug-in software can provide data and additional functionality to the navigation device. Plug-in software objects can be downloaded to the navigation device from a server which is also part of the framework. The download can be via a wireless network, during operation of the navigation device, and in response to user selections on the navigation device.

### FIELD OF THE INVENTION

The present invention relates to electronic navigation devices and a method of providing data to electronic navigation devices.

### BACKGROUND TO THE INVENTION

Navigation devices that provide route guidance are becoming increasingly popular, with a large number of different models available on the market. Almost all modem, consumer navigation systems determine position using GPS satellite signals. A map of the local vicinity is then retrieved from a map database, based on the determined position, and the position of the device is displayed on the map on a display screen of the device.

Route guidance is typically provided as well. A user can enter a desired destination to the navigation device and it will provide route guidance to the destination based on a computed route (using the map database and a routing algorithm) and continued detection of the position of the user.

In order to provide this functionality navigation devices need GPS hardware, data storage for a map database and processing hardware.

### Navigation System Architecture

A typical navigation device hardware architecture is illustrated schematically in FIG. 1. The navigation device 10 includes a processor 11 and a memory 12 associated with the processor 11, the memory for storing application programs for running on the processor. The memory 12 is typically a combination of ROM and RAM, The device 10 also includes a storage element 13 for storing geographic data. The storage element 13 is typically a CD-ROM, hard disc drive, or a solid state memory device such as a memory card. The navigation device 10 further includes a display 14 for displaying navigation information and a user interface to allow the user to enter destination information and to set personal preferences. The navigation device also includes a positioning system 15 which receives GPS data from a GPS antenna 16. The positioning system may also receive data from other position sensors 17, such as gyroscopes and wheel tick sensors.

To support the navigation device hardware shown in FIG. 1, a “fat client” software architecture (also sometimes referred to as “on-board”) can be employed to provide all mapping and navigation functionality locally on the device. A typical fat client software architecture is shown in FIG. 2 and includes a database 20, an operating system 21 and an application layer 22. The database includes map geometry, topology and attribute data, point-of-interest (POI) data, and address lookup data. The operating system may be based on a widely used operating system such as Microsoft's Windows Compact Edition operating system or may be a proprietary operating system. Applications running on the operating system include a map drawing application, a destination lookup application, a route calculation application, a map matching application and a route guidance application.

Fat clients have the advantages that they can operate completely independently of any other systems and infrastructure, they can be used at any location provided there is map coverage, they are very responsive to user input providing a high fidelity user experience, and they have no ongoing costs. They have the disadvantages that they have a relatively heavy footprint in terms of system resources and are difficult to deploy and update.

A widely used alternative to the fat client architecture for connected devices is the “thin client” (also sometimes referred to as “off-board”). Here, map data and the application program functionality reside on a remote navigation “server” which is used by a large number of navigation devices, typically through a wireless network. A typical thin client navigation system architecture is illustrated in FIG. 3. Client devices 30 and 31 communicate via a wireless network 32 to a network operator 33. Any network can be used. Examples are a cellular network, and an 802.11 LAN. The wireless network operator 33 has means to connect devices on the wireless network to the internet 36, including to a specific server 37 on the internet which is maintained by a navigation service provider. The server is capable of communicating with multiple client devices as necessary.

The client devices can be any suitable connected device, including a connected variant of the device shown in FIG. 1. Typically the client is a location aware connected PDA or mobile phone that is readily available to users of the wireless network. FIG. 4 shows the hardware architecture for a client device. The client device 40 includes a processor 41, memory 42, storage means 43, a display and user interface 44, and positioning system 45. The client has a communications means 46 used to communicate with a navigation server. The client device runs client software such as a web browser capable of displaying HTML content, or a WAP micro-browser capable of displaying WML content. The functionality of the client software is simplified largely to communicating with the server and presenting information provided by the server usually in the form of HTML or WML. The client is also responsible for receiving and processing user input and position data from the positioning system 45. Information sent from the server can include the user interface of the application, and navigation information such as maps and turn instructions generated by the server.

FIG. 5 is a schematic diagram of a typical hardware architecture for a server such as the server 37 mentioned with reference to FIG. 3. Preferably, the server is a multi-purpose hardware device such as a PC or rack mounted server commonly used to run server based applications. The server 50 includes a processor 51, memory 52, storage element 53 for storing both data, including geographic data, and software for running on the processor. The storage element 53 is typically a hard disc drive. In order that the server 50 can be controlled by an operator the server hardware includes control means 54 for operator control of the server. Example control means are a screen, keyboard, or remote connection such as telnet or a remote desktop. The server 50 further includes a communications means 55, allowing communications between client and server elements. Another communications means 56, which may be the same as 55, allows the server to communicate with the Internet. In some systems many clients are used in conjunction with fewer servers in which case the communications means 55 can scale to a large number of simultaneous client connections. Example connection scaling means are a load balancing server that distributes client connections to other servers if necessary.

FIG. 6 shows a typical software architecture for a navigation server such as the server 50 mentioned with reference to FIG. 5. The server software includes an operating system 60, basic server platform 61, and service software 63. The operating system may be based on a widely used operating system such as Microsoft's Windows or Linux. A basic server platform 61 provides components containing functionality commonly used by software programs. These components 61 can be supplied in conjunction with the operating system by the vendor supplying the operating system, by a third party, or can be created especially to support certain types of applications. Examples are a C standard library, C++ standard library, databases such as Oracle or Informix, and run-time environments and libraries for languages such as Java and .NET. The server contains map data 62 including map geometry, topology and attribute data, point-of-interest (POI) data, and address lookup data. The server runs a plural of navigation services 63 on the operating system, which utilise basic server platform components 61 and the map data 62. The navigation services 63 include a map drawing service, a destination lookup service, and a route calculation service and manoeuvre generation service. The functionality of the navigation server predominantly involves utilising the navigation services to generate content in a format such as HTML or WML containing both the user interface and navigation provision information for use on client devices.

Thin client systems have the advantages that it is easy to update the map data content and application utilised by client devices, they can have much richer map and POI data owing to the usually large storage capacity of the server where all data resides, they can be deployed and updated by making changes in one place on the server, and client devices are usually cheaper than in fat client systems. Thin client systems have the disadvantages that they only operate where a connection to the server is available, there are usually ongoing costs associated with transmitting data between the client and server and maintaining expensive server infrastructure, and they can have a poor quality user experience because of bandwidth limitations, network delays or high system load.

There are alternate connected architectures called smart clients which seek to retain the benefits of a fat client responsiveness and availability along with the benefits of thin client access to rich and up to date information. Smart clients run locally to provide an adaptive, responsive and rich user experience by leveraging local resources such as memory, storage, graphics and processing capability. Although they can work standalone smart clients are able to intelligently connect to and exchange data with remote systems to provide an even richer experience. Smart clients can optimise use of the communications channel providing cost and performance benefits since the user interface is not constantly shuttled from a server and is thus more responsive. Because smart clients are connected they can update themselves when new software versions are available often in the background by utilising the communications channel when it would otherwise be inactive.

Problems with Current Approaches

While the existing hardware and software architectures have worked well for users the addition of new functionality can be difficult irrespective of whether a fat, thin or smart client solution is used for both technical and logistic reasons.

Navigation products are developing rapidly in response to the availability of new map and content data that contains improved coverage and better attributes. In addition new forms of content are becoming available as more devices become connected and have access to a myriad of data and services. Content is a key differentiator and a central source from which a great deal of product functionality flows. This important role is, for the most part, not reflected in the design of present systems which seek to render content data into a uniform and predetermined form at the time the system is built. Such navigation systems can only utilise these specific forms of data and are unable to utilise new types of data that become available unless they are adapted. They are not “content-centric” and do not respond easily to changes in content data.

The problem is further compounded because to support a proliferation of functionality at build time navigation applications are becoming increasingly complex with many interacting pieces, frequently combined together in monolithic systems. Interdependencies between components can make it difficult to change part of the system software without affecting other parts of the system, and may mean that in effect a new product is released rather than an update to part of an existing product. In addition the need to wait for the development of all components before completing an integration and test cycle is leading to longer development times. Managing and coordinating such large projects and development teams is logistically difficult.

In order to add new features to the software, the steps shown in FIG. 7 must be performed sequentially. Initially a new feature is conceived 70 as additional data attributes become available. A map production tool which converts source data to the physical storage format of the system is changed if necessary 71 to support any new attributes that are related to the feature. Map data is built 72 using the updated map production system to produce data in a system specific physical storage format. The navigation engine is updated 73 in order that it can utilise changes made to the data Corresponding changes to support the new features are made 74 to various modules that are part of the user application. The user interface and graphics are modified to support the new functionality that is required and a fully integrated application is built from all the components mentioned 75.

A consequence of this serial design and production process is that specifically tailored products that take advantage of special data sources to meet the requirements of specific end users take a long time to develop. Instead, these products are often sidelined in favour of generic products that try to provide for everyone, but which end up delivering redundant functionality to many end users.

It is an object of the present invention to address some of the problems noted above or at least to provide the public with a useful choice.

### SUMMARY OF THE INVENTION

In the following description the term “plug-in software object” refers to items of content containing both executable program code and informational data. The term “navigation content provision framework” is intended to mean all elements of a navigation provision system which is also able to create, transport, and utilise plug-in software objects. The term “basic navigation framework” refers to those elements of a navigation content provision framework specific to a navigation device providing basic navigation functionality and which is able to utilise plug-in software objects. “Basic navigation functionality” in this context should be understood to mean commonly used navigation functionality such as; display of a map at any position, orientation and scale; functions for searching for and resolving to latitude/longitude coordinates destination information such as street addresses, and points of interest names and types; an optimal path calculation algorithm; a manoeuvre generation algorithm that converts an optimal path to a series of manoeuvres to be performed along the route; a vehicle positioning module that determines the current position by matching available positioning and motion information with data from a map; an instruction delivery mechanism that generates text, symbolic or audible prompts as they are required.

In a first aspect, the present invention provides a navigation content provision framework comprising:
a client device having a basic navigation framework for providing basic navigation functionality, the basic navigation framework supporting a fixed set of plug-in software objects.

Preferably, the content provision framework further includes a server, which is connected to the client device, and which is configured to provide plug-in software objects to the client device, the plug-in software objects providing additional functionality to the client device.

Preferably, the client device and the server are connected via a wireless connection. Alternatively, the client and server are located physically on the same device.

In a second aspect, the present invention provides a method of providing additional functionality to a client device having a basic navigation framework for providing basic navigation functionality, the basic navigation framework supporting a fixed set of plug-in software objects, comprising the step of:
providing plug-in software objects to the client device, the plug-in software objects providing additional functionality to the client device.

Preferably, the step of providing plug-in software objects includes providing plug-in software objects from a server via a wireless connection. Alternatively, or in addition, the step of providing plug-in software objects includes embedding the plug-in software objects within geographical data stored on the client device.

Preferably, program code and data contained in the plug-in software objects is integrated with the program functionality of client software on the client device while the program code executes on the client device.

Preferably, the program code contained in the plug-in software objects is formatted in a portable byte code, such as Java, .NET, or P-code; and is executed by a virtual machine contained on the client device. A portable byte code is independent of the platform on which it runs.

In a third aspect, the present invention provides a method of providing additional functionality to a client device having a basic navigation framework for providing basic navigation functionality, the basic navigation framework supporting fixed set of plug-in software objects, comprising the steps of:
providing plug-in software objects to the client device, and
storing the plug-in software objects temporarily or persistently on the client device, the plug-in software objects providing additional functionality to the client device when executed on the client device.

Preferably, the step of providing plug-in software objects comprises providing only those objects which are not already persistently or temporarily stored in the client device.

Preferably, the step of storing the plug-in software objects on the client device comprises storing the plug-in software objects until they are invalidated because the functionality or data they encapsulate has been withdrawn or updated. Alternatively, or in addition, the method further comprises deleting the plug-in software objects to make room for more recently generated plug-in software objects, owing to finite storage space limitations of the plug-in software object storage means.

Preferably, the method further includes the step of registering the plug-in software objects with the client device to indicate conditions, which if they occur, cause the plug-in software objects to be deleted.

In a fourth aspect, the present invention provides a navigation content provision framework comprising:
a server configured to provide plug-in software objects to client devices, the plug-in software objects providing additional functionality to the client devices when executed on the client devices.

Preferably, the server is configured to send details of available plug-ins to the client devices.

In a fifth aspect, the present invention provides a navigation content provision framework comprising:
a client device having a basic navigation framework for providing basic navigation functionality, the basic navigation framework supporting fixed set of plug-in software objects;
an input device connected to, or part of, the client device, for providing an input signal in accordance with a property associated with the client device;
wherein the plug-in software objects are programmed to execute on the client device in response to a signal from the input device.

Preferably, the input device is an absolute positioning means such as a GPS sensor. Alternatively, or in addition, the input device may detect the speed of the client device, the ambient temperature, ambient light levels, water depth, the time or specific forms of user input.

Preferably, the plug-in software objects are programmed to register with the client-device to specify relevant trigger signals and conditions.

In a sixth aspect, the present invention provides a method of providing navigation functionality or navigation information to a user of a client device having a basic navigation framework for providing basic navigation functionality, the basic navigation framework supporting fixed set of plug-in software objects, comprising the step of:
providing plug-in software objects which are programmed to execute on the client device in response to a specific condition associated with the client device.

Preferably, the specific condition is related to the position of the client device.

In a seventh aspect, the present invention provides a navigation content provision framework comprising:
a client device having a basic navigation framework for providing basic navigation functionality, the basic navigation framework supporting fixed set of plug-in software objects; and
a server in communication with the client device and the Internet;
wherein the client device includes means to send to the server a request for content, and wherein the server includes means for requesting the content from sources connected to the Internet based on the request from the client device, means for receiving the resulting content and means for transmitting it to the client device in the form of a plug-in software object.

Preferably, the client device includes a position determining system. Preferably, the server provides a plug-in software object to the client device that, when executed on the client device, provides a means for a user to request content.

Preferably, the position of the client device as determined by the position determining system is sent with the request for content and the content transmitted to the client device is tailored in dependence on the position. Alternatively, or in addition, the request for content is tailored dependent on the current travel itinerary, travel speed, time of day, date, or specific user defined preferences.

Preferably, the server provides plug-in software objects to the client device that provide additional functionality to the client device.

In an eighth aspect, the present invention provides a method of displaying content from an content source on a client device having a display, comprising the steps of:
receiving a request for content from the client device at a remote navigation server;
sending the request from the navigation server to a server hosting the content on the Internet;
receiving the content at the navigation server;
reformatting the content as a plug-in software object; and
sending the plug-in software object to the client device;
the plug-in software object being programmed to execute on the client device to render information to the display of the client device.

Preferably, an indication of the position of the client device is received with the request for content at the server.

Preferably, the plug-in software object is programmed to generate a customised information display when executed on a client device. Preferably, the client device further includes a map display and the plug-in software object is programmed to alter the map display or annotate it with additional information.

Preferably, the method further includes the step of sending a first plug-in software object to the client device from the server, the first plug-in software object when executed on the client device, allowing content to be requested. Preferably, when executed, the first plug-in software object also generates a user interface to support user customisation of the content request when this is required by an Internet content source.

In a ninth aspect, the present invention provides a navigation content provision, framework comprising:
a client device having a display; and
a server in communication with the client device and the Internet; and having means to access content sources on the Internet.
wherein the client device is operative to display icons representing favourite content requests on the display of the client device, and wherein the client device is operative to send a predetermined content request to the Internet content source in response to selection of an icon on the display by a user.

Preferably, the icons representing favourite content requests are integrated into an icon based menu of the client device.

Preferably, the Internet content source is a database, search engine, or remote sensor device, Preferably, the content request is a search query or command.

In a tenth aspect, the present invention provides a system for providing a navigation user interface on a client device comprising:
a client device having a display, a basic navigation framework for providing basic navigation functionality, the basic navigation framework supporting fixed set of plug-in software objects; and
a server in communication with the client device; having a destination database containing details of special destinations together with plug-in software objects specific to each special destination;
wherein, in use, when a user selects on the client device a destination for routing, the client device requests from the server whether the selected destination is in the destination database, and, if the selected destination is in the destination database, sends to the client a plug-in software object that adds functionality to the client device.

In an eleventh aspect, the present invention provides a method for providing a navigation user interface on a client device comprising the steps of:
designating a destination as a special destination; and
when a user requests route guidance to that destination, providing a destination specific user interface on the client device.

Preferably, the client device is connected to a central server containing a live special destination database. Preferably, the destination specific user interface is provided to the client device in the form of a software plug-in or plug-ins.

Preferably, the special destination is a business. Preferably, the destination specific user interface includes a logo, colours or advertising associated with the destination.

In a twelfth aspect, the present invention provides a navigation content provision framework comprising:
a first device, having a basic navigation framework for providing basic navigation functionality and means for connecting to a wireless communications network;
wherein the first device has a user interface that allows a user of the first to specify a location; and
wherein, in use, the first device sends automatically generated information dependent on the location to a remote device having means to connect to the wireless communications network.

The information may be in any format. Preferably, the automatically generated information is in the form of an SMS or MMS message.

Preferably, the first device is a client device in accordance with the first or, fifth aspect of the present invention. The remote device may be any similar or dissimilar device connected to the wireless network.

Preferably, the automatically generated information includes information about the specified location, or route guidance information indicating how to reach the specified location. Preferably the automatically generated information also contains advertising content for a business.

In a thirteenth aspect, the present invention provides a method of providing navigation information to a device connected to a navigation content provision framework, the navigation content provision framework comprising a first device having a basic navigation framework for providing basic navigation functionality and means for connecting to a wireless communications network, the basic navigation framework supporting fixed set of plug-in software objects, and a server that can provide plug-in software objects to the first device, the plug-in software objects providing additional functionality to the first device when executed on the first device; comprising the steps of:
receiving a plug-in software object from the server at the first device;
allowing a user of the first device to specify a location; and
sending automatically customised information dependent on the location to a remote device having means to connect to the wireless communications network;
the plug-in software object being automatically executed on the first device, allowing the information sent to the remote device to be customised.

The information may be in any format. Preferably, the information is in the form of an SMS or MMS message.

Preferably, the first device is a client device in accordance with the first or fifth aspect of the present invention. The remote device may be any similar or dissimilar device connected to the wireless network.

Preferably, the information sent from the first to the remote device includes information about the specified location, or route guidance information indicating bow to reach the specified location. Preferably the information also contains advertising content for a business.

### BRIEF DESCRIPTION OF THE DRAWINGS

Examples of the present invention will now be described in detail with reference to the accompanying drawings, in which:

FIG. 1 is a schematic illustration of a personal navigation device in accordance with the prior art;

FIG. 2 is a schematic illustration of a software architecture used in a fat client system of the type illustrated in FIG. 1, in accordance with the prior art;

FIG. 3 is a schematic illustration of a thin client navigation system architecture in accordance with prior art;

FIG. 4 is a schematic illustration of a thin client device hardware architecture in accordance with prior art;

FIG. 5 is a schematic representation of a server hardware architecture in accordance with prior art;

FIG. 6 is a schematic representation of a server software architecture in accordance with prior art;

FIG. 7 shows a feature integration process for navigation software in accordance with the prior art;

FIG. 8 is a schematic illustration of a system architecture having all elements separated in accordance with the present invention;

FIG. 9 is a schematic illustration of a system architecture consisting of client and server elements in accordance with the present invention;

FIG. 10 is a schematic illustration of a system architecture for a combined client and server navigation device connected to the internet in accordance with the present invention;

FIG. 11 is a schematic illustration of a system architecture for a stand alone device in accordance with the present invention;

FIG. 12 is a schematic illustration of the hardware and software elements comprising a client device in accordance with the present invention;

FIG. 13 is a schematic illustration of the relationship between a basic navigation platform and a basic navigation framework in accordance with the present invention;

FIG. 14 is a schematic illustration of elements related to a plug-in software object framework in accordance with the present invention;

FIG. 15 shows an example plug-in software object activation lifecycle in accordance with the present invention;

FIG. 16 is a schematic illustration of the software architecture of a content channel service in accordance with the present invention;

FIG. 17 shows an example process for creating and transferring plug-in software objects from a server in accordance with the present invention;

FIG. 18 shows an example process for requesting and transferring plug-in software objects from a server in accordance with the present invention;

FIG. 19 is a schematic illustration of a system architecture including a directory server in accordance with the present invention;

FIG. 20 is a schematic illustration of a directory service software architecture in accordance with the present invention;

FIG. 21 shows an example process for a content channel signing on and off with a directory service in accordance with the present invention;

FIG. 22 shows an example process for subscribing to a content channel in accordance with the present invention;

FIG. 23 is a schematic illustration of elements of the security framework in accordance with the present invention;

FIG. 24 shows an example process for a client device subscribing to a content channel securely in accordance with the present invention;

FIG. 25 is a schematic illustration of the relationship between a user interaction framework and other system elements in accordance with the present invention;

FIG. 26 shows an example process for obtaining internet content in accordance with the present invention;

FIG. 27 shows an example process for subscribing to a web site in accordance with the present invention;

FIG. 28 shows example user interface screens from a tiered menu system in accordance with the present invention;

FIG. 29 shows an example search wizard user interface for Google searching in accordance with the present invention;

FIG. 30 shows example result display user interface screens in accordance with the present invention;

FIG. 31 shows an example process for search driven through and icon based menu in accordance with the present invention;

FIG. 32 shows example customised navigation user interface in accordance with the present invention;

FIG. 33 shows example POI web portal user interface in accordance with the present invention;

FIG. 34 shows an example process for generating a custom user interface for a sponsored destination in accordance with the present invention;

FIG. 35 is a schematic illustration of a system for device to device messaging in accordance with the present invention;

FIG. 36 shows an example meeting invitation user interface in accordance with the present invention; and

FIG. 37 shows an example meeting invitation and acceptance process in accordance with the present invention.

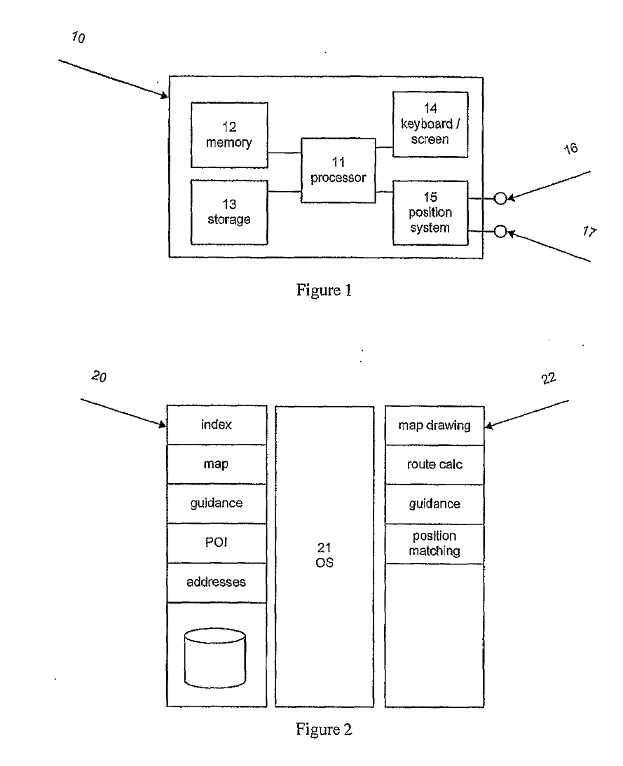

### DETAILED DESCRIPTION OF THE INVENTION

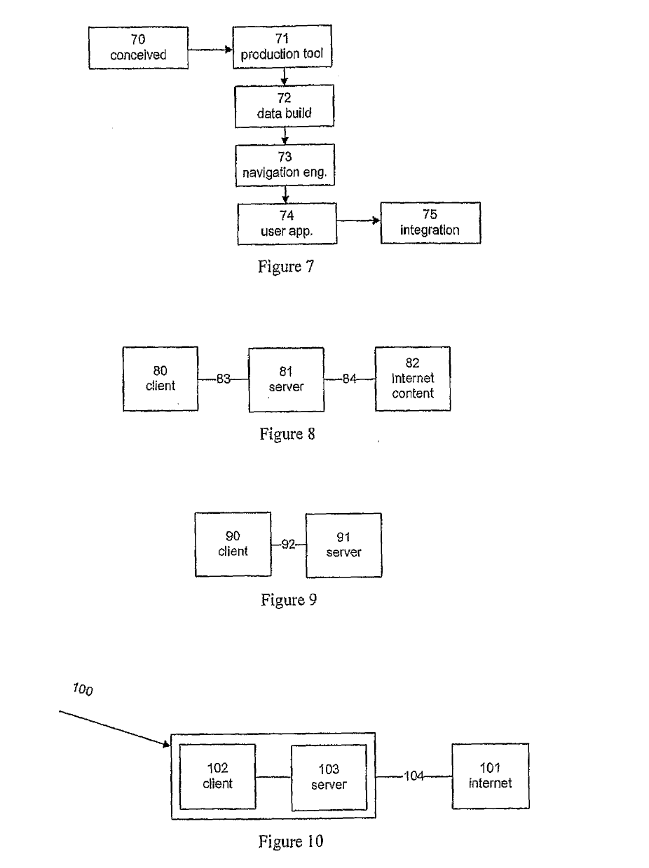

As has already been discussed when reviewing current approaches to navigation system design, present navigation systems cannot be easily adapted to utilise new forms of content data. Such navigation systems, which are not content centric, can only utilise new types of data that become available through an adaptation process illustrated in FIG. 7.

The present invention addresses current problems by moving to a content centric design where changes in system functionality are driven by changes in content. This is achieved through provision of a navigation content provision framework having for the ability to integrate with navigation devices, access, deliver, and integrate content, and extend the functionality of the basic system. Content can be delivered in the form of plug-in software objects that extend program functionality. Plug-in software objects can be integrated with basic navigation devices incorporating the basic navigation framework in order to provide different “skins” that customise the basic navigation framework for a particular user or for a particular purpose. Additional content provided to the device can originate from many sources, including external sources in connected systems. Provision of such content through plug-in software objects, as plug-in software objects, and to plug-in software objects facilitates the delivery of services by a location based service provider or a third party.

The navigation content provision framework, when implemented, allows the same hardware and basic navigation platform to form the basis for many different types of navigation and location based products. The client hardware and basic navigation framework can be identical for many products and can be developed independently of specific plug-in software object functionality. Development of tailored products in accordance with the present invention is far simpler than in prior navigation system architectures and features can be added after the basic system has been built and released. The provision of new or adapted functionality in this manner can reduce the delay between when software features are conceived and when they are made available to end users. The features delivered can be targeted to suit the needs of specific users as those needs arise and as the means for leveraging those needs for business purposes are identified.

The navigation content provision framework discussed can consist of client and server elements that may be incorporated within the same physical device or may be connected by any means, including through the Internet and wirelessly. A basic navigation client element of the system provides basic navigation functionality which can be extended by program elements that are dynamically distributed between clients and a server. Through the navigation content provision framework any third party content sources and services, including those provided through Internet web sites, can be integrated easily. The navigation content provision framework enables systems differentiated by the content and features provided to be built according to defined mechanisms and application program interfaces.

FIGS. 8-37 discuss a variety of system configurations that represent possible embodiments of the invention. Subsequent sections describe the makeup, functionality and interactions between, system elements in much more detail.

FIG. 8 shows a typical system in accordance with the present invention, which is configured with fully separated elements. The navigation client 80 is separated from the server 81 by a wired or wireless communications channel 83. Example channels are, serial, USB, Ethernet, Bluetooth, 802.11 wireless, and cellular. The server 81 is able to access, via any wired or wireless communications channel 84 (including those channels already described with reference to 83), a plurality of Internet content providers 82, including web sites, web services, and live sensor devices visible on the Internet. Examples of applications enabled by incorporating this design are delivery of real time traffic information and local search provided by Internet search engines.

FIG. 9 illustrates a simplified system configuration including just a navigation client element 90 and a server element 91. Here the client 90 is separated from the server 91 by a wired or wireless connection 92 of the same type as connection 83. The server 91 can communicate with the client but has no provision to communicate with the Internet or any external content source. Instead content is stored directly on the server and is accessed as needed by the client through the connection 92. Examples of applications enabled by incorporating this design are an extended geocoding (address lookup) service utilising a large point of interest or road database, and a keyword search of defined content such as a proprietary tourist or information guide.

FIG. 10 illustrates another system configuration incorporating the present invention where a navigation device 100 contains both the navigation client 102 and server 103 hardware and software elements. The device 100 is able to communicate to various sources of Internet content 101 already described with reference to Internet content providers 82 via a wired or wireless communications link 104 already described with reference to communications channel 84. Here the navigation device itself 100 communicates with the content sources 101 directly to obtain live and up to date data, New functionality or changes to the format or location of the Internet content source 101 need to be installed manually, typically by the user of the navigation device 100. Example applications enabled by this system configuration are Delivery of real time traffic information in a format such as TMC and local search provided by the web service interfaces of specific Internet search engines.

FIG. 11 shows the simplest configuration of a system in accordance with the present invention. In this configuration a navigation device 110 operates as a stand alone device not connected to any network and contains the client 112 and server 113 elements of the system in a similar fashion to the system described with reference to 100. However this configuration is different in that content is directly accessed by the client device. Content is stored within a non volatile permanent or removable storage medium 111 provided with or by the client device. Example storage means are flash memory, battery backed ram, hard drive, CD ROM and removable memory storage card such as MMC, Compact Flash or SD. Live content from external sources is not available in this configuration, instead the storage medium 111 must be replaced or updated to obtain new functionality or data that is more current. Content updates must be installed manually, typically by the user of the navigation device 110. An example application enabled by this system configuration is a tourism product utilising mapping to provide an interactive city guide for a specific city or area.

### Basic Navigation Platform

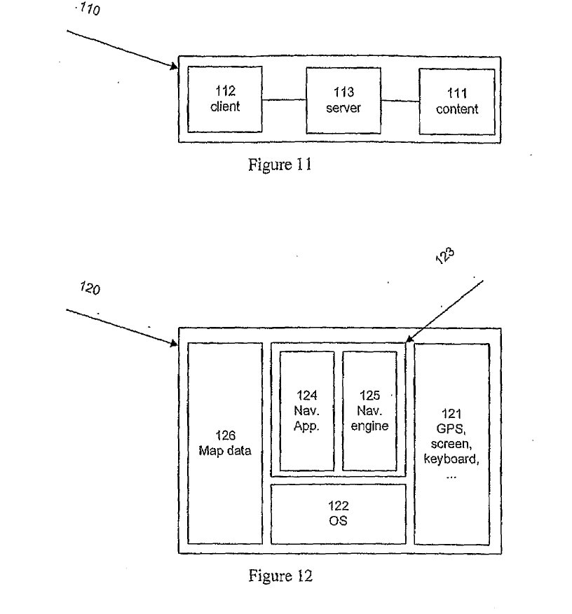

FIG. 12 illustrates the structure of a navigation client device providing a basic navigation platform in accordance with the present invention. The basic navigation device of FIG. 12 consists of a hardware device 120, including the necessary hardware for provision of navigation functionality 121, and for running basic navigation software platform software 123. This basic navigation platform is utilised in conjunction with a basic navigation framework to provide products that are differentiated through the provision of additional functionality. The basic navigation software platform incorporates a navigation application 124 that accesses map and/or content data 126, and typically, but not always, relies on the presence of an operating system 122. Examples of operating systems suitable for use in the basic navigation platform are Linux, Windows CE, and QNX. The navigation application software 124 provides an end user navigation experience by providing a navigation user interface which utilises a navigation engine 125 incorporating a range of navigation functions and algorithms relying on the map data 126.

The basic navigation platform software 123 provides an application that incorporates commonly used basic navigation functionality supported by the navigation engine 125. Basic navigation functionality includes commonly used navigation functionality such as: display of a map at any position, orientation and scale, with options to customise the display by placing or superimposing specified images, annotations or text on the map; functions for searching for and resolving to latitude/longitude coordinates human readable destination information such as street addresses, points of interest names and types; an optimal path calculation algorithm customisable by adjusting the cost criteria and/or constraints, such as the A* algorithm; a manoeuvre generation algorithm that converts an optimal path to a series of manoeuvres to be performed along the route, with customisation of manoeuvre generation conditions and parameters; a vehicle positioning module that determines the current position of the device on the map by matching available positioning and motion information with map data; and an instruction delivery mechanism that reconciles the present position against the manoeuvre list to generate text, symbolic or audible prompts in real-time as they are required, and according to a configured voice file and instruction grammar.

### Navigation Content Provision Framework Definition

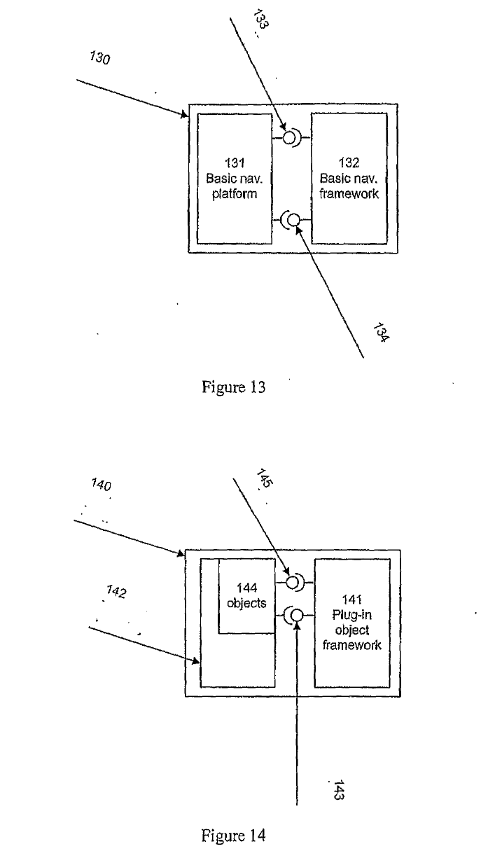

FIG. 13 illustrates navigation client software 130 containing basic navigation platform software 131 as described with reference to 123 and a basic navigation framework 132 in accordance with the present invention. The basic navigation framework 132 is clearly separate from the basic navigation platform and is thus not a navigation application itself; however it extends navigation applications which provide basic navigation functionality. The basic navigation platform and other aspects of the system infrastructure discussed later provide a platform for the basic navigation framework to use through an API 133 defined by the basic navigation framework. The platform API 133 allows the basic navigation framework to access basic navigation functions provided by the navigation client device 130. Similarly, the basic navigation platform 131 can access the basic navigation framework 132 through a framework API 134 which allows the platform to invoke basic navigation framework functionality as required.

The basic navigation platform is typically adapted in view of the basic navigation framework in order to work properly with the framework. Preferably, the basic navigation platform software contains a core navigation engine 125 which does not change in view of the basic navigation framework but the navigation application 124 that incorporates the navigation engine is adapted or extended to provide the platform API 133 that the basic navigation framework expects, and to access the basic navigation framework appropriately through the framework API 134.

In a preferred embodiment the APIs 133 and 134 and the implementation of the basic navigation framework do not change when used in conjunction with different basic navigation platforms. Standardisation of the framework API and production of the framework with reference to programming guidelines ensures maximum portability of the framework. The basic navigation framework is also implemented using appropriate languages and technologies in such a manner that a single implementation is compatible with different basic navigation products that are produced. These measures, if incorporated into a basic navigation framework implementation, are designed ensure the fastest proliferation of that implementation to the maximum range of navigation products.

The navigation content provision framework consists of more than just the basic navigation framework incorporated into a navigation client device. In fact, in several embodiments of the present invention shown in FIGS. 8 through 11 navigation content provision framework functionality is distributed between client and server elements. Some parts of the various navigation content provision framework aspects which are discussed in subsequent sections apply only to the client, some to the server, and some to both elements of the system.

### Plug-in Software Object Framework

A basic navigation framework as illustrated in FIG. 14 can be extended through the provision of plug-in software objects 144. Plug-in software objects are utilised by the plug-in software object framework 141, a component of the basic navigation framework 140, to provide additional functionality by fulfilling specific roles in certain situations. These roles and also the set of fixed plug-in software object types are defined for a particular embodiment of the framework. The range of additional functionality that can be provided is potentially very large due to the inherent flexibility of the framework and possible variation of plug-in software object functionality. However, the additional functionality is constrained overall during normal operation of the framework, mainly as to what aspects of the framework are exposed to the plug-in software objects, and when and how the plug-in software objects are utilised.

The plug-in software objects 144 that are used on client devices contain code and data segments that can extend the basic navigation framework and navigation application. The plug-in software objects are executed by an execution engine 142 utilised by the plug-in software object framework 141 to run specific elements of the plug-in software objects code segments as required. The execution engine 142 is usually not part of the basic navigation framework 140, but it could be. Instead, the execution engine is either already incorporated with the basic navigation platform 131, or alternatively is supplied by a third party. The execution engine can have any implementation; examples are script engines, rule bases, or machine code that is binary compatible with the navigation client device. Preferably, the execution engine complies with some industry standard design of execution engines and is a virtual machine utilising a byte code interpreter or just in time compiler. Preferably, in addition, the program contained in the plug-in software objects is formatted in a byte code that is executed by the virtual machine. Examples of such schemes are Java, .NET, and P-code.

The plug-in software object framework 141 manages the acquisition, storage and application of plug-in software objects 144. Plug-in software objects utilised by the framework 141 can be obtained by any means supported by the navigation client device 120. Examples are built in plug-in software objects that are already part of the application, objects from a storage card, objects from data within geographical map data accessed directly by the client device, or objects supplied through any wired or wireless connection to a remote server. In preferred embodiments having the configurations illustrated in FIGS. 8 and 9; plug-in software objects are supplied from a server by wireless connection as and when they are required by the basic navigation framework.

In one embodiment, the program and data contained in the plug-in software objects 144 is integrated with the program functionality of the basic navigation framework 140 while it is still executing. That is, the integration occurs seamlessly and during normal operation of the client device, and without the client device requiring any reset or entering any special program installation state. Preferably, although program execution proceeds seamlessly from a logical perspective, the user is informed of the cause of any transmission or other latencies that may impact the response and usability of the client device as plug-in software objects are transferred and installed.

In a preferred embodiment the plug-in software object framework 141 incorporates a means to persistently or temporarily store plug-in software objects in a plug-in software object cache once they have been obtained. This mechanism is intended to avoid repeated transfer of identical plug-in software objects to the client device. Any temporary or persistent storage means may be used as a cache. Examples are RAM or flash storage memory within the client device, a hard drive, removable storage cards such as multimedia, compact flash, and SD cards. Preferably, the stored objects are managed by the plug-in software object framework 141 using a least recently used prioritised list. The purpose of the priority list is to allow the least recently used plug-in software objects to be discarded in order to make way for more recently used or supplied, plug-in software objects, owing to the finite nature of the cache temporary or persistent storage means.

The execution machine 142 that is part of the plug-in software object framework in a preferred embodiment executes the program contained within the plug-in software objects but also allows the plug-in software objects to access the resources of the frameworks 140 and 141 and hence the resources of the basic navigation platform 131. This access is supported by provision of a framework API 143 that is exposed to the program code contained within plug-in software objects. Preferably, the framework API 143 exposed to plug-in software objects is internal to the framework, however depending on the embodiment of the invention, plug-in software objects may additionally have access to other support APIs and functions necessary for regular operation of plug-in software objects being operated by the execution engine. Examples of these APIs are mathematical or calculation functions, string manipulation functions, memory management functions and other functions defined by the basic navigation platform API 133. In a preferred embodiment the framework API 143 is language independent in the sense that similar functionality is supported no matter what forms of plug-in software objects are used, or language they are developed in, and so long as the correct functions are called and function argument passing conventions are followed. The plug-in objects 144 also have an API 145 that can be used by the plug-in object framework 141 to interact with the objects. It is described in further detail in subsequent sections.

### Object Lifecycle Framework

Plug-in software objects 144 that have been acquired by the basic navigation framework 140 and which are temporarily or persistently stored on the client device 120 are initially in an inactive state. That is the code contained within the objects is not being executed, instead it is waiting to be triggered by the occurrence of specific events, wherein it is executed by the execution engine. Events are generated by the basic navigation framework 132 usually in response to input signals received from the basic navigation platform 131. In a preferred embodiment of the navigation content provision framework a pre-determined and fixed set of events are supported, limiting the types of plug-in software object activations that can occur.

The basic navigation platform 131 can provide various input signals that generate events within the framework 132 for triggering plug-in software objects. The input signal can come from a device connected to or part of the client device 120, and reflects some property associated with the client device or the outside world. Example properties are time, position, user speed, temperature, light levels, properties of an associated vehicle engine and water depth in a boating environment. Any external or internal environmental sensor input such as an absolute positioning means including GPS and/or dead reckoning sensor can be used to trigger plug-in software objects. Additionally, sensor devices that detect input directly from the user such as a keyboard or touch pad can generate triggering input signals. The triggering input signal may even be generated when receiving a message through a wired or wirelessly connected communications channel.

The execution engine activates plug-in software objects in response to events generated by the framework 132, where those objects have indicated to the framework their interest in knowing about certain events. Examples of types of events that plug-in software objects may wish to know about are various forms of user interaction activity, location changes or absolute location, time transitions, windows, or elapsed time, and the receipt of messages. Events of interest to a plug-in software object are within the plug-in software object's event scope. Events outside a plug-in software object's event scope are not passed to the plug-in software object by the framework.

Events within the event scope of plug-in software objects are passed by the framework 140 to the plug-in software objects 144 through an event handler API which is part of an API 145 provided by the plug-in software object. The API 145 is used by the framework to interact with plug-in software objects. The event handler API allows the plug-in software object execution state to be escalated through three stages from fully dormant to fully operative. In a first fully dormant state, no code from the plug-in software object is being executed by the execution machine; however the event scope of the plug-in software object has been established by the framework. In a second background operative state, a background event handler contained in the plug-in software object is used to process events within the event scope. The event handler determines using the program and data stored in the object whether the third state of object activation should be invoked. Preferably, while in the second activation state, objects have limited access to the APIs provided by the navigation content provision framework. In a preferred embodiment no user interface related framework APIs can be used by objects in the second state of activation. In a third fully operative state, plug-in software objects have full access to framework APIs, which enable them to perform useful tasks by utilising the resources of the framework, and hence of the basic navigation platform.

The framework supports plug-in software object state escalation in order that plug-in software objects can determine their own trigger conditions. The scheme supports objects having very complex trigger conditions determined by rules and data contained within the object, whilst keeping the framework as simple as possible. For example, in a preferred embodiment plug-in software objects can be triggered by changes in position in relation to a defined geofence area, or a route corridor. Examples of applications utilising this method of triggering are vehicle compliance applications, and interactive tour guides that deliver tourism content at certain locations. In some embodiments plug-in software objects can be triggered at certain times or after a certain time has elapsed. Example applications utilising this form of triggering are a personal reminder alarm, or, in conjunction with position based triggering, an advertising application delivering advertising during the opening hours of a nearby facility.

In the third fully operative state plug-in software objects are able to utilise a full set of framework APIs. Exactly what APIs are accessible depends on the exact implementation of the framework; however in preferred embodiments plug-in software objects in this state provide a user interface that allows them to interact directly with users of the client navigation device. In addition, plug-in software objects in the third state are able to trigger other events or objects, to utilise and alter the behaviour of basic navigation functions such as routing and map display, request and display content, trigger other events and objects and to transmit and receive messages. In fact the nature of the activities that can be performed by objects in this state and related aspects of the navigation content provision framework supporting these activities is, in most part, the subject of subsequent discussions.

As mentioned earlier, plug-in software objects are stored by the client device until they are deleted because the storage capacity of the client device plug-in software object storage cache has been reached, and that space is required for more recently used or acquired plug-in software objects. However, in a preferred embodiment plug-in software objects can also be deleted from the plug-in software object cache early for a variety of other reasons, examples of which are that the object is of a certain type and has performed its designated function, that the time window for use of the plug-in software object has expired, and that the object has been invalidated at the server because the functionality or data it encapsulates has been withdrawn or updated. In addition, in a preferred embodiment plug-in software objects may define their own expiry conditions. Preferably, the mechanism which enables this utilises the plug-in software object event handler to monitor events of interest, and to determine conditions, which if they occur, cause the plug-in software object to notify the framework through a suitable API that expiry should occur.

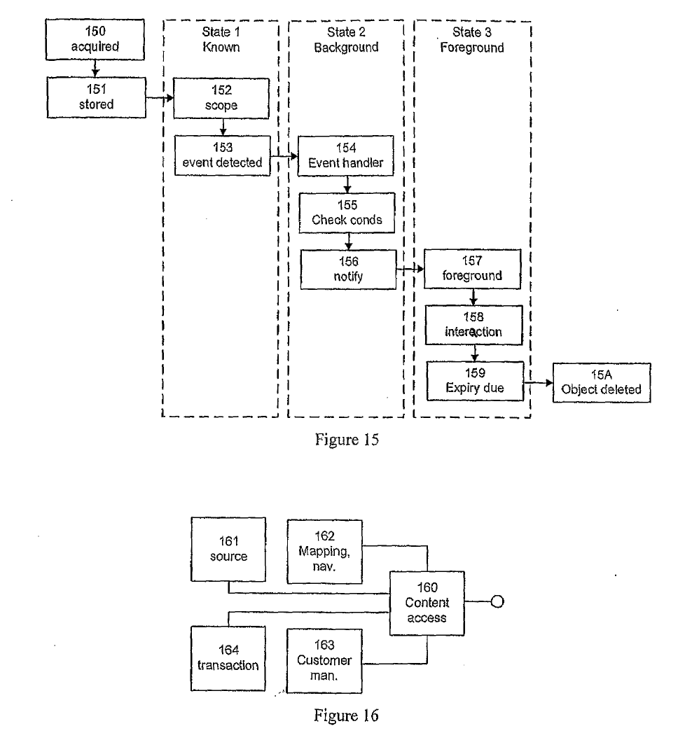

FIG. 15 illustrates various points within the lifecycle of a plug-in software object designed to complete a single task and then expire. The object is acquired 150 by the basic navigation framework 140 and is subsequently stored 151 in the plug-in software object cache of the client device 150. The framework interrogates 152 the plug-in software object by examining information contained in the plug-in object to determine its event scope, wherein the object enters the first completely dormant state. The framework, responding to triggers provided by the basic navigation platform determines that an event within scope has occurred 153, wherein the framework executes 154 the event handler of the plug-in software object. The event handler determines 155 from the event reported and internal information that sufficient conditions are met for full activation. The event handler notifies 156 the framework using a framework API 143 that full activation of the object is required. The framework utilises the object execution engine 142 to activate 157 the foreground function of the object, wherein it enters the third fully operative state and completes 158 its set task. After completing its set task the object indicates 159 to the framework that object expiry is due. After receiving the expiry notification the framework expires the object by deleting 15A the object from the plug-in software object cache.

### Content Channel Service Framework

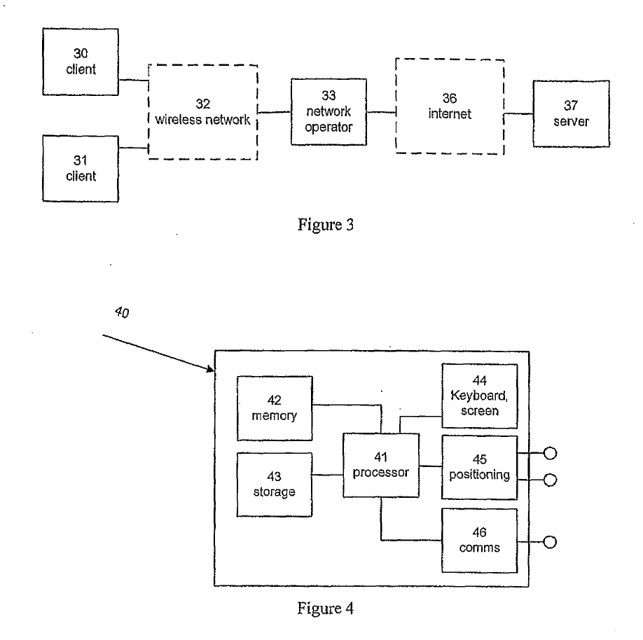

In the embodiments of the navigation content provision framework depicted in FIGS. 8 through 11 the functionality of a navigation client element is extended through the provision of plug-in software objects from server elements having means of communicating with client elements. As shown in FIGS. 10 and 11 the client and server elements may be present physically in the same device in which case the communications means is internal to the device. As shown in FIGS. 8 and 9 the client and server elements may be in separate devices connected by a wired or wireless connection. FIG. 3 shows a prior system where a wireless connection is used and the server device is capable of communicating with multiple client devices as necessary. Such a system can be utilised by a location based service provider for the purpose of providing plug-in software objects wirelessly to client devices in accordance with the present invention.

In accordance with the present invention the software services 63 described with reference to FIG. 6 running on the server can include services that deliver plug-in objects to navigation clients. The plug-in objects delivered by the server are from a content channel service on the server. Content channels extend the functionality of the system and the content channels that are provided in the system determine the scope of functionality available to users of navigation client devices. Content channels are the only customisable elements that differentiate one system from another for a given implementation of the navigation content provision framework. Content channels are a key part of the navigation content provision framework although the implementation of content channels may vary from one system to another.

A content channel is a single type of content that can be “subscribed” to by an end user of the navigation client device. Examples are tourist information for New York, travel information, such as flight timetables, or a restaurant guide. Content channels are provided by a location based service provider and in a preferred embodiment of the invention end users determine the nature of their own personal experience with the client devices through individual selection of content channels. Preferably, in addition, some content channels are provided completely free to users whilst others support one or a number of revenue generation methods to fund or enable continued access. Almost any business model can be applied; examples are subscriptions, pay per use, proportion of sale, broadcast advertising, pay per click or pay per view, and targeted marketing.

FIG. 16 illustrates the architecture of a content channel service in a preferred embodiment of the navigation content provision framework. A content access layer 160 provides a standard form of interface between content channels and the remainder of the system. This allows the content channel to be managed in the system and to assemble and provide content objects to the navigation client device. Through the content access layer the content channel receives requests from plug-in software objects originating from this content channel but which are running on the navigation client device. In response to those requests the content access layer performs the necessary processing, mapping, and transformation operations to assemble and supply the requested content, typically in the form of plug-in software objects, to the content channel.

The content channel provides content to end users by utilising data from a content source 161. The content source can be of any form and also can combine multiple actual sources. Examples are stored data and or files, stored data in a database, a live content source on the Internet, information generated in real time, and live sensor data that is available to the content channel. In a preferred embodiment, stored data and files contain object templates which provide fragments of executable program code that can be combined together and with data by the content access layer to form a complete plug-in software object.

In a preferred embodiment the content channel contains mapping and navigation module 162, which provides map data, navigation functionality, and utility functions commonly required to access or process map geometry and data. The navigation and utility functions are used by the content access layer 160 of content channels and change very infrequently. Examples are geometric calculation and spatial operations, database access primitives, searching algorithms, standard address search and resolution algorithms, and route calculation algorithms.

A customer management module 163 manages content channel subscriptions and access rights of individual users. There are no “global” passwords or user identity in the system, instead, each content channel in the system is responsible for maintaining the specific user information that it requires. Examples of customer specific information are contact details, settings and preferences, security information and subscription status.

Finally, FIG. 16 shows a transaction module 164 which collects information about the use of the content channel service overall by all customers of the channel, by groups of customers or by individuals. The information can be of any type, examples are subscription uptake or decline, time spent using a channel, age of customer using a channel, volume of content sent, and content channel specific activity. Preferably, the information is collated in order to generate statistics to analyse the usage pattern of the service provided, and for revenue generation purposes. There is no detailed transaction tracking mechanism applied globally in the system, instead transaction information is maintained separately by location based service providers for each content channel. The transaction reporting module is an important means through which revenue can be generated by the location based service provider.

### Content Channel Communication Framework

In a preferred embodiment of the framework communications between navigation client devices and content channel services are standardised as part of the content channel communication framework. This framework provides a messaging protocol that supports the transmission of plug-in software objects and content channel specific information. Preferably, the communications protocol used is consistent with widely used industry standards. Examples are SOAP and CORBA. Via this mechanism the functionality of client devices can be updated and plug-in software objects on the client device can gain access to live and up to date information.

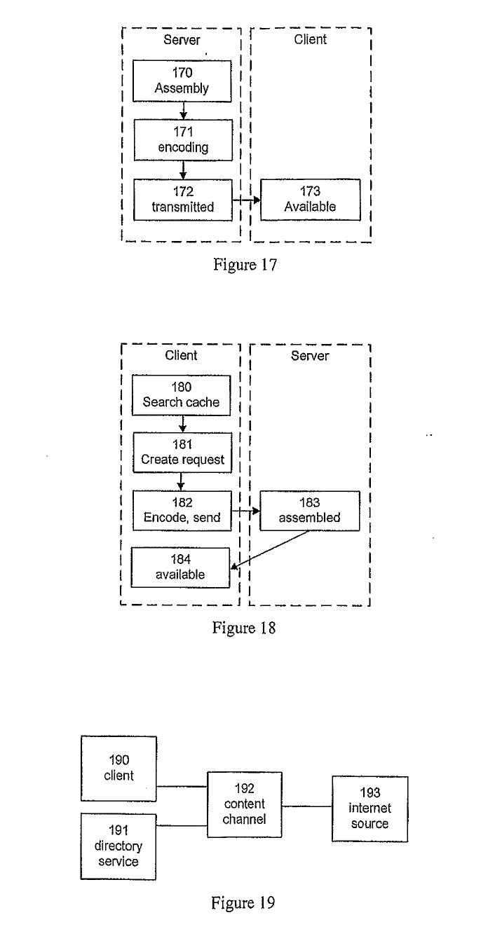

FIG. 17 illustrates the steps that occur in order to deliver content from a content channel service to a navigation client. Plug-in software objects and/or other content are assembled 170 by the service, in response to requests originating from the navigation client. Software plug-in objects and other content items are encoded 171 according a communications protocol specified as part of the embodiment of the framework. In a preferred embodiment this entails serialising the items from a binary format such as CIL to a transmission format such as MIME or base 64, and then encapsulating the items using XML according to the SOAP protocol so they can later be identified and recovered. The encoded data is transmitted 172 to the client device by any means. Once received by the client, the encoded data is decoded 173 to make the plug-in software objects and/or other content data available to the basic navigation framework of the client device.

As described earlier, the client device incorporates a plug-in software object storage cache, the purpose of which is to avoid repeated transfer of identical plug-in software objects. Only the plug-in software objects that are not already stored on the client need be provided by the content channel on the server. In a preferred embodiment global unique identifiers are used to identify unique instances of plug-in software objects. The client navigation framework compares the global unique identifiers of objects required with the identifiers of all stored objects before initiating object transfers from a content channel. Ideally, the request for plug-in software objects only contains the global unique identifiers of objects not already stored on the client device.

FIG. 18 illustrates the sequence of actions that occur in a preferred embodiment of the invention when the basic navigation framework needs to obtain a plug-in software object. The client device searches 180 the plug-in software object cache on the client device, and determines using guaranteed unique identifiers that the object required is not already within the client device. A content request message is created 181 which includes the unique identifier of the missing object. The content request message is encoded by the client and sent 182 to the server using a process similar to steps 171 to 173 except that the roles of the client and server are reversed. In response to the request, content is assembled by the server and transmitted 183 to the client device according to steps 170-173. The plug-in software object is available 184 for use with the basic navigation framework.

### Directory Service Framework

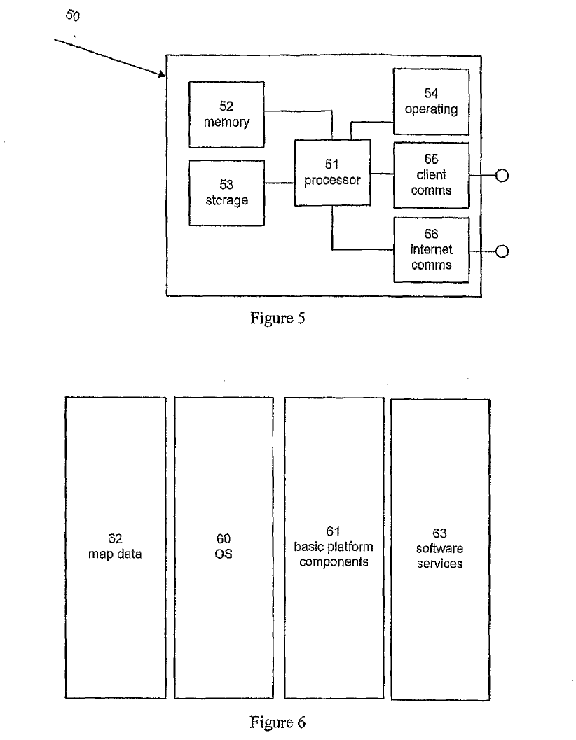

FIG. 19 shows the relationship between content channels and a device in use for embodiments of the invention corresponding to FIGS. 8 and 9. The system is divided into a directory server 191, a content channel server 192, and a navigation client device 190 which is able to execute plug-in software objects. The servers 191 and 192 can be separate servers having hardware architecture in accordance with that shown in FIG. 5. Alternatively servers 191 and 192 can be housed in the same device, which may be the same device as the client 190 in systems configured as shown in FIGS. 10 and 11. Plug-in software objects are provided to the navigation client device 190 by a plural of content channels 192 which optionally utilise sources of information or services from the Internet 193 to provide a particular type of content. The directory service is maintained by a location based service provider and regulates what content channels are available to end users. Content channels appear standardised to the directory service to facilitate the management of content channels by the directory service, and to underpin the preferred method of extending the system which is through provision of more content channels. The directory service is the first point of contact for communications between a client device and a content channel. After discovering what content channels are available via the directory service a client device initiates direct connections with individual content channels as required, and, in response to user activity, plug-in software object transfer and content channel specific communications occur.

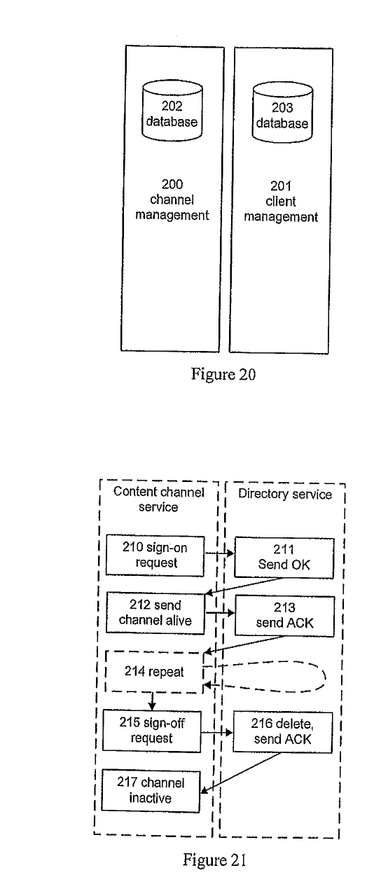

FIG. 20 shows the elements comprising a preferred embodiment of the directory service software. A channel management module 200 provides a mechanism that allows one or a plurality of channels to “sign-on” with the directory service. The overall functionality of the system at any given time depends on which channels are signed-on. A client module 201 included in the directory service allows client devices to discover which content channels are available. Channel details for each channel, such as a name and a description, are stored in a channel information database 202 and are sent by a client management module to the client device for display to the end user. Information about each device that can use the system is stored in a device information database 203. The use of the databases 202 and 203 is described here, and also in subsequent sections.

Content channels can be provided by any location based service provider, and may be a different provider than the provider of the directory service. In order to be listed by the directory service, content channels must sign-on with the directory service, and maintain contact while they remain active. Content channels can sign-off when the content channel service wishes to go down for maintenance or for other reasons. In this way the directory service is constantly aware of which channels are active and which are inactive. If the directory service is not active it is possible for content channels to remain operating normally for those customers that are already subscribed to the content channel. FIG. 21 illustrates a typical sign-on, keep alive, and sign-off cycle for a content channel. In step 210 the content channel sends a sign-on request to the channel management module of the directory service. The directory service adds the channel to the list of active channels and responds 211 with a signed-on message. The content channel maintains its status by sending 212 an “I am alive” message to the directory service. The directory service replies 213 with an acknowledgement. In step 214 steps 212 and 213 are repeated periodically while the content channel wishes to remain signed-on with the directory service. When the content channel wishes to sign-off with the directory service it sends 215 a sign-off request message to the directory service. The content channel is removed from the directory service channel listing and the directory service sends 216 an acknowledge message to the content channel. The content channel then is de-activated 217.

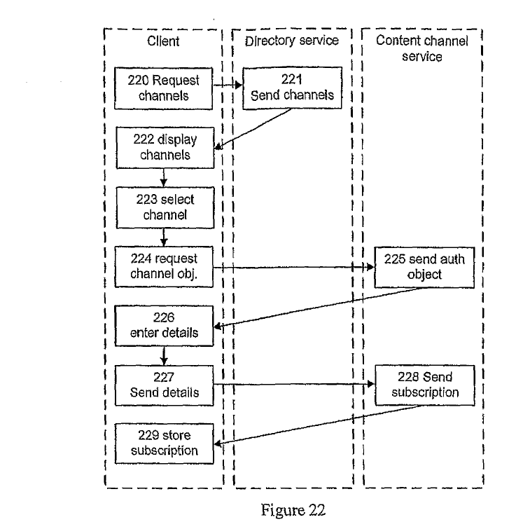

FIG. 22 shows the process of a user subscribing to a content channel via a client device. In a first step, details of available content channels are stored by the directory service can be requested 220 by a client device. In a second step 221, the directory service sends a list of signed-on channels to client device. The list of channels is displayed on the client device at step 222 and the user given the option to select a channel. When the user selects a channel the directory service has completed its task and, the client initiates communications directly with the relevant content channel service. At step 223, the client device sends a subscription request 224 for to the content channel. If required, at step 22S, the content channel sends an authentication object back to the client device in order to obtain user details for subscription purposes. The entry of details may be performed automatically by the client device at step 226 using details if stored in the client device. Otherwise if the user has elected not to not store details they may need to be entered by the user each time the details are required. The required details are sent back to the content channel at step 227, where they are stored by the customer management module. Notification of a successful content channel subscription is sent to the client device from the content channel at step 228. The channel subscription is stored 229 on the client device for future use in communicating with the content channel. The channel subscription information can contain any information specific to a user that the content channel service deems as important.

### Security Framework

Because the system is connected, a security framework is required to secure communications between elements of the system and to authenticate the identity of each element. All communications in the system are encrypted using a public/private key cryptography scheme such as RSA. Furthermore, the secure content is signed as originating from a trusted source using digital certificates. Finally, a digital rights management system controls the participation of individual client devices and content channel services in the system. The detail of the design and implementation of these technologies is well known prior art.

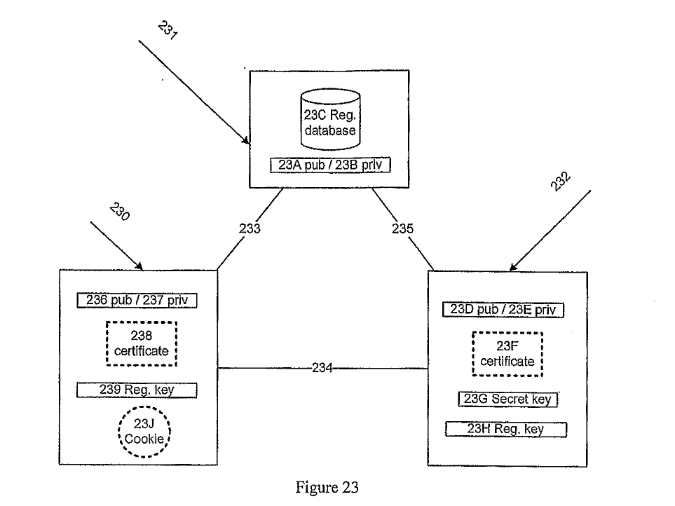

FIG. 23 illustrates elements that are important within the security framework. The role of and relationships between various elements is discussed below with reference to FIG. 23. In the system communications are secured across a communications channel 233 between clients 230 and a directory service 231, and across a communications channel 234 between clients 230 and content channel services 232. Communications are also secured across a communications channel 235 between content channel services 232 and a directory service 231.

Communications across the channels 233, 234 and 235 are encrypted using public/private key cryptography. Clients have a public/private key pair 236/237 generated at the client. Content channels have a public/private key pair 23D/23E generated at the content channel. The directory service has a public/private key pair 23A/23B generated at the directory service. Parties wishing to receive encrypted messages from other parties transmit their public key to the other party. The other party encrypts the message it wishes to send to the original party using the public key, and the original party decrypts the message using a secret private key 237, 23B and 23E only know to the original party.

The identity of a party sending messages can be established through digital signatures and digital certificates 238 and 23F. A party sending messages to another party can sign the message using a digital signature. The signature is created by the sending party by creating a message digest from the message being sent and encrypting the message digest using the private key only know to the sender. The message digest is calculated using a well known algorithm such as MD5. The receiver uses the known public key of the sender to decrypt the message digest and from the message calculates their own message digest which is compared against the decrypted digital signature. If the two match then the message has been sent by the owner of the known public key. In order to verify that the public key was issued by a trusted source, instead of by an intermediary intercepting and sending on all messages, a digital certificate issued from a trusted source can be used. The digital certificate is issued by a certificate authority know to both the sender and receiver. The digital certificate is issued to a sender by encrypting the public key of the sender and some information that is unique to the sender using the private key of the certificate authority. The message can be decrypted using the public key of the certificate authority. Now, each time a sender sends a message to a receiver the digital certificate containing the public key of the sender can be included. The certificate can be decrypted by the receiving party using the known public key of the certificate authority. The public key of the sender contained in the certificate can be compared against the public key reported by the sender. If the two match then the sender is who they say they are.

In the case of the system shown in FIG. 23 the certificate authority is the directory service. This is because the directory service controls the access rights of both individuals and services to the system. It is a gateway for all devices to all content channel services. A digital certificate enabling access to the system must be obtained once for each client device and content channel wishing to be part of the system. The issuing of certificates is controlled by the directory service using a system of “registration” keys 239 and 23H, and a registration database 23C at the directory server. The registration database 23C contains all registration keys that are valid in the system, along with details of whether the key has already been used to obtain a certificate. For a particular content channel or device only one certificate is issued, thereafter that certificate is used for all communications within the system. Registration keys are issued by the directory service along with copies of the client device software, or when a new content channel agreement between the directory service provider and a content channel provider is made. A client device or content channel wishing to register must send unique information to the directory service, including the registration key, and information related to the unique identity of the registering device, so that the registration key can be marked as used when a certificate has been issued.

For client devices to be used at all in the system they must be registered with the directory service first. The directory service does not need to know who the customers are, only that the client device software is valid. In effect, the customer base is actually a device base that the directory service can on-sell to content channel providers by permitting those content channels to have access to the system. For this scheme to work, devices must contain unique serial numbers to differentiate one device from another. Examples are the serial number of a storage device, an internal serial number, or an IMEA number. The device serial number is included in the unique information sent by a client device to the directory service that it uses to issue a digital certificate, The registration database 23B contains both the registration key and the client device unique serial number once a certificate has been issued.

Client devices cannot access the directory service other than for registration purposes initially. Once a device has been registered and a certificate issued it can examine the content channels available through the directory service and can communicate with content channels directly. Content channels must also register with the directory service before they are available through the directory service. Content channels are issued certificates through a similar registration process to client devices. The content channel uses its certificate in all future communications with the directory service and with client devices.

Client devices can be pre-registered in some situations. If the client device software for navigation and content provision is pre-installed by the manufacturer then the device can be pre-registered by the manufacturer. The same or a similar mechanism as just described is used, but the manufacturer instead of the customer deals with the registration process.

The security means just described are important because the subscription to content channels is made on an individual basis by end users of the system. Knowing that the device is a valid device in the system is important for directory service providers as this is the means for on-selling customers. Knowing the identity of the customer is important for content channels because the customer may have to pay to access the content that the content channel provides. A device registered with the directory service can use its directory service certificate to subscribe to content channels known to the directory service. The content channel verifies that the client device can be connected to the system because the client device supplies a certificate from the directory service. Similarly the client device verifies that the content channel is valid because the content channel supplies a certificate from the directory service.

When the user subscribes to a content channel the content channel returns information to the client device that allows future access to the content channel by the client device. The information returned is a “secure cookie” 23J which is specific to the client device. Secure cookies are analogous to the regular cookies used by many websites to remember user specific information but the cookie is encrypted by the content channel, using a secret key only known to the content channel. The secure cookie is passed to the content channel by the client device whenever it communicates with the content channel. The cookie contains information the content channel wishes to store on the client device, including information about the client device, or the user. The content channel may update the secure cookie at any time if the stored information needs to be changed. The secure cookie once stored on the client device gives the user of the client device access rights to content provided by a particular content channel. In fact the client device in this manner can store all access rights to content channels in the system, on a key chain in the client device, in an encrypted form unknown to the client device. The cookie is encrypted using a secret key 23H only known to the content channel, typically using a commonly known block symmetric cipher such as RC5 or 3DES. All channels subscribed to and rights to access those channels are stored locally on the client device as each secure cookie need only be associated with a known content channel for it to be used.

Because the basic navigation framework is capable of running plug-in software objects that interact with the client device or the user, including plug-in software objects that ask the user for personal information, only content objects from a trusted source are accepted by the basic navigation framework. To implement this scheme plug-in software objects sent by a content channel are signed using a certificate issued to the content channel by the directory service. This prevents plug-in objects that are not from a content channel authorised by the directory service from being run.

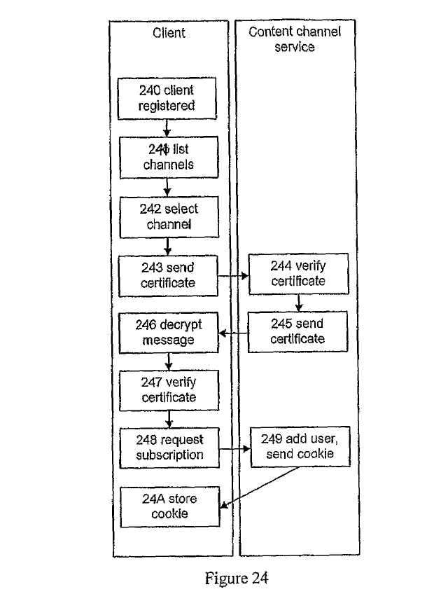

FIG. 24 shows an example process for securely subscribing a client device to a content channel. Initially in step 240 it is assumed that the client device has registered with the directory service to obtain a certificate from the directory service. The user then has access to the directory service and chooses to list in step 41 the content channels available. In step 242 through the user interface of the client device the user selects a particular content channel to subscribe to. The client device creates a message containing information about the device and the public key. The message is signed using the client private key and sent in step 243 along with the certificate issued by the directory service to the content channel. The content channel service verifies in step 244 the client device by decrypting the message signature using the client's public key, and decrypting the certificate using the trusted directory service public key. The content channel, having authenticated the sender can now send encrypted messages to the client device using the client device public key. In step 245 the content channel service sends its unique information in a message signed using the content channel private key along with the certificate issued to it by the directory service. In step 246 the client device can decrypt the message from the content channel using its private key, and can authenticate in step 247 the content channel using the signed message and certificate from the directory service. The client device can now send encrypted messages to the content channel using the public key of the content channel. In step 248 the client device exchanges encrypted information as necessary in accordance with steps 224 through 227 described with reference to FIG. 22. Information required by the content channel for subscription typically includes the unique device identifier. The content channel receives this information and creates a secure cookie using client unique information, including the device identifier, and includes the cookie in the reply 249 to the client device. The reply is created in accordance with step 228 described with reference to FIG. 22. The client device updates its subscription database and stores 24A the secure cookie in its key chain for use in all future communications with the content channel.

### User Interaction Framework

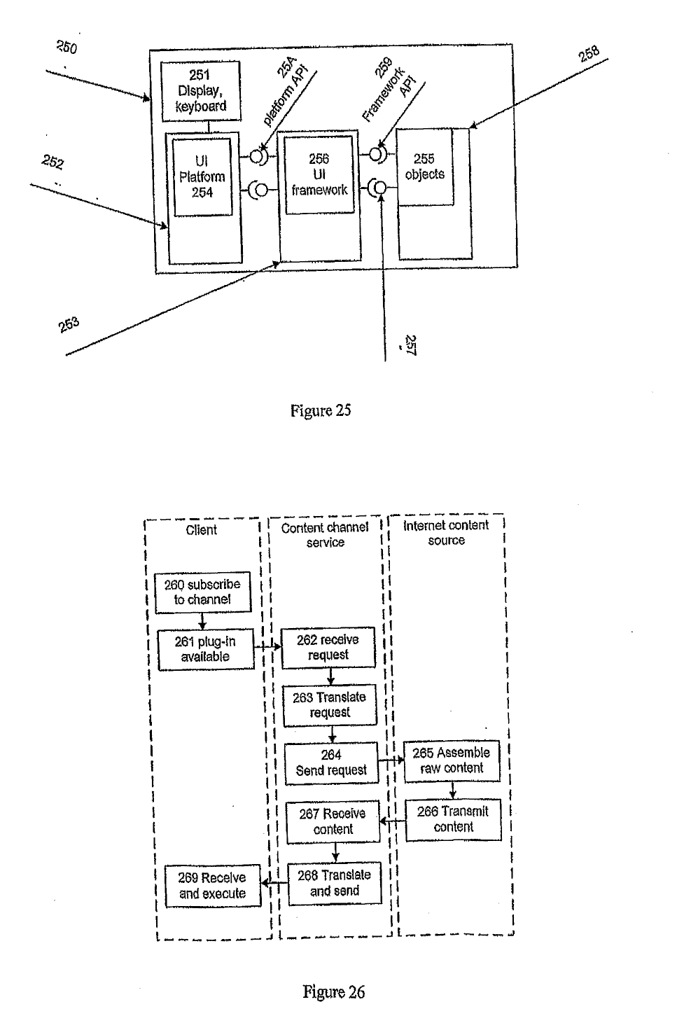

FIG. 25 shows a diagram of a navigation client device 250 incorporating a screen and keyboard 251 used to provide a user interface to end users, basic navigation platform software 252, and a basic navigation framework 253. The framework 253 utilises software plug-in objects 255 executed by the object execution machine in conjunction with a user interaction framework 256 that is available to the plug-in objects. Plug-in objects utilise the user interactive framework 256 while they are fully active to present information and obtain input from a user of the client device 250. The user interaction framework is supported by the implementation of user interaction platform software 254 which is part of the basic navigation platform 252 of the client device.

The user interaction framework 256 is the only mechanism by which plug-in software objects are able to present information to the user. The framework provides a series of APIs 259 used by plug-in software objects 255 to display information and content. Example primitives are a canvas, lines, circles, polygons, text, and bitmapped images. In a preferred embodiment the primitives are implemented as a standardised graphics API which is passed through mostly directly to the platform layer where it is translated to platform specific function calls to the platform API 25A. Preferably, in addition, the graphics API of the framework and platform layer are conformant with, but usually a subset of, an industry standard graphics API. The platform layer may have to implement this API if such a conformant implementation is not already available for the client device. Example APIs are Java AWT, open GL and Windows GDI. Preferably, standard graphics image formats are supported by the graphics API; examples are GIF, PNG, Jpeg and windows BMP.

In addition to the graphics API used for basic rendering the user interaction framework provides a fixed set of higher level information display and user interaction widgets. Examples are display of a text list, display and select one or a number of items from a list, display a message and obtain a decision, obtain text input. In a preferred embodiment, these widgets appear standardised in terms of their API to the plug-in software objects but they are implemented according to platform specific conventions of the basic navigation platform. This allows the implementation of plug-in software objects to be uniform across different navigation client devices, but the look and feel of the user interface to remain consistent with each different basic navigation platform. It also allows the basic navigation platform software to be optimised for a particular environment. For example, the basic navigation platform may implement voice recognition to obtain some forms of input, or text to speech for output.

### Internet Content Delivery Framework

FIGS. 8 and 10 show embodiments of the present invention including a server in communication with a client, and the Internet. The client is able to request from the server content from a content channel, and the content channel includes means for requesting the content from sources connected to the Internet based on the request from the client. The content requested is received by the content channel and it is converted into a plug-in software object and transmitted to the client in order to extend the functionality of the client. The Internet content source can be any source. In a preferred embodiment the content source is a search engine, and the content requested is search results web page. Thus, in this embodiment, the navigation content provision framework described above, can access Internet search services examples of which are Google Local, Windows Live Local, MSN City Search, and Zagat.

The content request sent from the client to the content channel includes a variety of situational information in addition to the information already described in step 181 in FIG. 18. Preferably, the request for content includes situational information pertaining to the client device and/or the past, present and future activities of the user. Examples of situational information are the position of the client device as determined by a position determining system, the current travel destination or itinerary, travel speed, time of day and/or date. Preferably, the content is tailored by the content channel or an Internet content source used by the content channel dependent on the situational information. In accordance with step 181 described with reference to FIG. 18, the request for content preferably includes personal preferences of the user and the content is also tailored in accordance with the personal preferences. Example personal preferences are that no images should be sent, only summary results should be sent, and that the default radius of area to search is 0.5 miles.

Content channels are operative to download requested content, such as web pages, via the Internet and to reformat the content into active objects for transmission to navigation client devices. The content channel implements a proxy which is incorporated into the content access layer 170 of the content channel. In a preferred embodiment utilising web pages as the source of Internet content the proxy automatically requests the web page, populates components of the page as necessary to issue an information request, and parses a resulting web page to extract the content requested. The content channel proxy on the server performs most of the work in handling content requests made by the client device.

Requests for content, including those for plug-in objects and Internet content can be generated by plug-in software objects earlier provided to the client device, when executed by the client device. The requesting plug-in object can customise the content request as required by automatically providing details that are needed at the server. Examples are, user details required for login and subscription at a website. This ensures that user effort is minimised and that the privacy of personal details is maintained. Preferably, the requesting plug-in, when executed, can also generate a user interface to support user customisation of the content request. This may be required by content sources, such as Internet content sources, when data fields cannot be predicted automatically but are required as part of the content request.

During step 181 in FIG. 18 a client device creates a content request containing information, which as discussed can also contain situational information. In addition, in a preferred embodiment, the information includes the global unique identifier of the plug-in object creating the content request. The global unique identifier, when sent, allows the server to determine the identity and currency of plug-in software objects issuing content requests. A request issued by the client to the server from an out of date plug-in software object can be denied or ignored by the server, or otherwise processed by the server if the request is still understood. A plug-in software object can be out of date for a variety of reasons. An example is that the functionality the plug-in software object supports has been updated or withdrawn. In this case it may be possible for the server to update the plug-in software object automatically at the client by transmitting an up to date version of the plug-in software object to the client. Knowing the origin of the content request can be useful for other reasons. An example is that in targeted marketing applications it is possible to generate revenue by determining whether a content request is the result of sending a plug-in containing a particular advertisement.

The present invention provides a user interaction framework 256 having a method of displaying content from a content source on a client device incorporating a display. In a preferred embodiment, a server provides Internet content formatted as plug-in software objects to a client device. Preferably, the plug-in software objects supplied, when executed, generate an information display dependent on the Internet content received. The information displayed may be any information that can be displayed through the user interaction framework. Example information displays are a list of results, details about a particular result, and an image. Preferably, the client device further includes a map display and the plug-in software object received alters the map display or annotates the map with additional information. Examples are route paths, turn instructions, area outlines, more detailed map content, and images. In a preferred embodiment the information displayed includes advertising content, and the advertiser pays the location based service provider to have the advertising content delivered.

FIG. 26 illustrates the process whereby content from the Internet is requested and displayed on the client device. Initially the user subscribes 260 to a content channel as explained with reference to FIG. 22. After subscribing, a first plug-in software object is received 261 by the client device, enabling further software plug-in objects to be requested. The content channel receives 262 a request generated by the first plug-in object as explained with reference to steps 180 through 182 in FIG. 18. Upon receiving the content request from the client device, the content channel proxy in the content channel translates 263 the content request into an Internet content request. The Internet content request is transmitted 264 to the Internet content source, wherein the Internet content source assembles 265 and transmits 266 the content in raw form to the content channel application. The content in raw form is received 267 by the content channel where it is encoded, transmitted and made available 268 as a plug-in object at the client device in accordance with steps 170 through 173 described with reference to FIG. 17. The plug-in object once available at the client device is executed 269 on the client device to render information to the display of the client device.

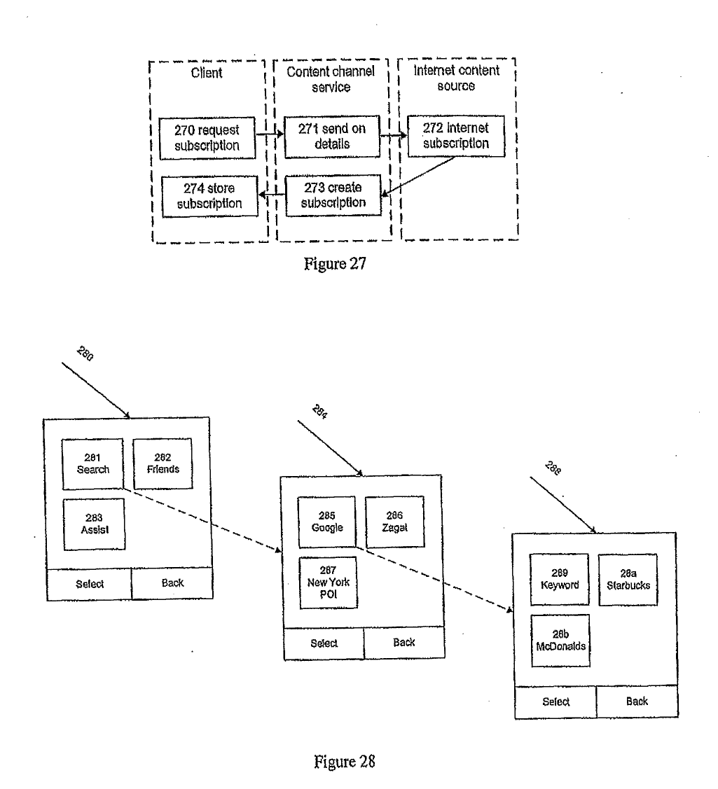

FIG. 22 shows an example process for subscribing to a content channel. This process is further extended when the content channel utilises content from an Internet content source that also requires subscription. The process for subscribing to such a content channel is illustrated in FIG. 27. Initially steps 220 through 224 described with reference to FIG. 22 are followed 270 to request a subscription. However because the internet content source also requires subscription, the subscription information is sent on to the Internet content provider at step 271. The details are used to complete a successful subscription to the Internet content source. Upon a successful subscription with the internet content source, notification is sent back in step 272 to the content channel. The content channel sends at step 273 a secure cookie, including information related to Internet subscription, to the client device and it is stored at step 274 on the client device to enable subsequent access and automatic login to the internet content source.

### Icon Based Menu Framework

In the embodiments of the framework shown in FIGS. 8 through 11 a client has means to access a variety of content sources, including local content sources, content from a server, and content on the Internet. In a preferred embodiment, content provided by these systems can be accessed efficiently through an icon based menu provided by the basic navigation framework. Using icons in this way to represent menu options allows users to more quickly recognize and select items of interest, and is especially useful in portable navigation devices having a small form factor and small screen size. The method of icons is not only aesthetically pleasing but also language independent and easily implemented on different platforms. The method also supports the provision of user interface themes on the client device; in particular brand themes can be accommodated through suitable selection of menu icons.

Preferably, the icon menu is provided by the user interaction framework and has a tiered structure that is configurable. A first tier is related to various categories of service provided by the location based service provider, a second tier relates to specific services, and other tiers relate to specific functionality associated with those services. Preferably the services are related to a content channel and are provided by plug-in objects that are supplied by the content channel. The menu system is merely part of the framework for utilising plug-in software objects and the addition of new plug-in objects can cause the menu system to be extended by the framework. The icons in the menu provide a means for users to run plug-in objects that deliver new functionality, including functionality that further extends the menu system.

FIG. 28 shows an example of a tiered menu system containing three tiers. The example shows a preferred type of user interface for the menu system comprising of an array of icons. In this example each icon in a first tier 280 represents a category of service including, search services 281, friend finding services 282, and assistance services 283. Selecting the search icon 281 in this example leads to a second tier menu 284 having the same user interface format as the first tier. Each icon in the second tier menu represents a content channel that provides search results. The second tier menu contains content channels supporting Google Local 285, Zagat 286, and New York tourism POI 287 search channels. The Google local and Zagat channels provide content from a remote server but the New York tourism channel provides content from a database on the client. In this example, a third tier menu 288 is activated by selecting the Google icon 285 from the second tier menu. In effect activating the third tier menu executes a plug-in provided by the Google local search channel and the plug-in in conjunction with the user interaction framework generates the third tier menu. The third tier menu for the Google Local search channel contains several icons, a keyword icon 289 supporting any Google search, and a Starbucks icon 28a and McDonald's icon representing a specific Google searches.

Typically the service categories shown in the first tier menu 280 are designated by the location based service provider, and this information is provided by the directory service. The content channels available through the directory service are assigned to a service category, also preferably by the location based service provider. However, the second tier menu 284 is user defined. Preferably, the icons available in all possible second tier menus are consistent with the service provider assignments of content channels to content channel categories. Preferably, in addition, icons are only shown at the second level corresponding to content channels that have been selected by the user. The user therefore, intrinsically configures the makeup of second tier menus through their content channel selections.

The third menu tier in the example illustrated in FIG. 28 is specific to the Google search channel and contained an icon representing a general search as well as icons representing a Google searches for Starbucks coffee shops and McDonalds restaurants. The Starbucks and McDonalds icons are specific examples of the more general case where icons in a menu represent predetermined content requests that can be issued by simply selecting an icon. Content requests are issued to a content channel, and preferably the content channel delivers the requested content, including latitude longitude locations related to the content, to the client device in the form of a plug-in object. Any content source can be used by the content channel, including content sources on the Internet. Preferably, an Internet content source is used, and the content request causes at the server a predetermined content request to be issued by the content channel proxy to the Internet content source. The Internet content source may be a database, search engine, or remote sensor device and the content request invokes a search query or command. Preferably, the content channel represents favourite content requests of users as icons, and allows those users the ability to select and customise their own requests. In this way the delivery of specific information for specific users as and when they require it is streamlined from a usability perspective.

For navigation systems of the type described above which allow for Internet searching, favourite nearest searches can be represented by icons in an icon based menu. The user interface screen shown in FIG. 28 includes an array of icons which represent specific search requests. A Starbucks icon and a McDonald's icon are shown. A user can select these icons to search Google Local in order to locate the outlets that are nearest to the current location of the client device as determined by a position determining means in the client device. Search engines such as Google Local and Yahoo Local are currently text driven. The operator types text corresponding to the information that they are searching for and the search engine retrieves a number of matching results, including the result location. A nearest favourite search function driven by icons of this nature on a navigation device is desirable because it removes the need for alphanumeric data to be entered repeatedly by the user.

With an icon based menu in accordance with the present invention, invoking a favourite search simply consists of selecting the corresponding icon. Preferably, each icon representing a search includes a set of search parameters that constrain or filter the search in some way. Example search parameters are limiting the search to a certain distance from the client device, only including results of a certain cost or below, or only searching locations offering specials. Preferably, in addition, display parameters affecting the way that results are to be presented are included in the search definition. Example display parameters are that a map view should be used, icons representing locations should be named, and that small text should be used. The available search and display parameters are determined by the content channel and plug-in object supplied by the content channel that invokes search requests.

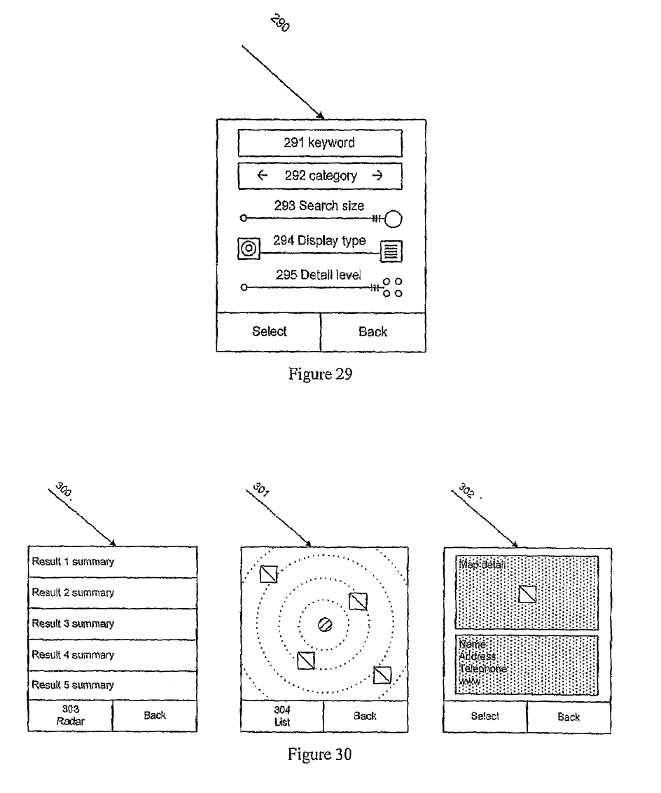

Preferably, a plug-in object supporting favourite searches provides a user interface that allows the user to define and customise search requests, including the searches themselves, and any additional search and display parameters. In a preferred embodiment the user interface is a wizard that allows easy entry and editing of a search definition, and the search definition to be saved as a favourite search. Preferably searches that are entered in this manner that are not saved as favourite searches are stored in a recent search list and subsequently can also be edited, reused and/or saved as favourite searches. In the example shown in FIG. 29 the search wizard of the Google Local search channels is invoked when selecting the Google Icon 289 in the third tier search menu 288. FIG. 29 shows an example search wizard screen provided by a plug-in object from the Google search channel. The search wizard screen 290 provides a keyword field 291 that allows entry of search keywords through the user interaction framework. In addition the screen contains a category field 292 that allows all or a certain type of results to be searched, and a search radius field 293 restricts the search area to be within a certain distance of the client device location. A display type field 294 allows several different types of result displays to be used and a display detail field 295 allows a greater or lesser amount of information detail to be shown.

The provision of an icon based menu and content channels supporting favourite searches can be used to support revenue generation for the location based service provider and third party businesses. Many different types of icon menu plug-in functionality can be provided and almost any business model can be used for revenue generation. In an example target marketing application a content channel is provided free to users and the content channel delivers icons to an icon menu supported by the content channel containing special offers or discounts for products of interest to those users. In this case the icons represent favourite searches for locations selling the products of interest, and the search definition is pre-defined and provided automatically by the content channel. The business model for such an application could be an advertising model where advertisers pay for space on the icon menu, or could be a sales model where sales transactions generate revenue. Applications of this nature are supported in the system because the customer profile is known to a location based service provider, and the transaction reporting module of a content channel service can monitor user behaviour including product and destination selections. This information allows better targeted marketing activities to occur.

As explained previously content received by the client device such as search results can be displayed in a variety of ways through the user interaction framework. FIG. 30 shows a preferred embodiment of the search result display where results are optionally displayed as a result list 300 or as a radar display 301 and the user can easily switch between the two types of display. In the list display 300 results are shown as a result list ordered by increasing radial distance from the current location of the navigation device. Each entry in the list display shows the distance of the result from the current location, the name of the result and the type of result found. In this display mode the user can switch to radar display mode by selecting the radar icon 303. The results of searches may be shown on a radar type display 301 where each search result is displayed as an icon on the display. The icons are shown relative to the position of the user, the position of the user being at the centre of the display. The user can easily switch to the list display 301 by selecting the list icon 304. In both result displays each search result can be selected to reveal more detail about the result. More detail is shown by a results detail display 302 which includes the information already shown in the list display 300 as well as a close up map view of the result vicinity, and further information about the destination if it is available, such as a description or image related to the search result. The result shown in the result detail display can be selected to be used for a variety of purposes using the select icon. Examples purposes of result selection are to use it as a destination, to add it to a trip itinerary, to use it as a meeting location, and to save it as a favourite destination. Further examples related to result selection achieved in this manner are discussed in subsequent sections.

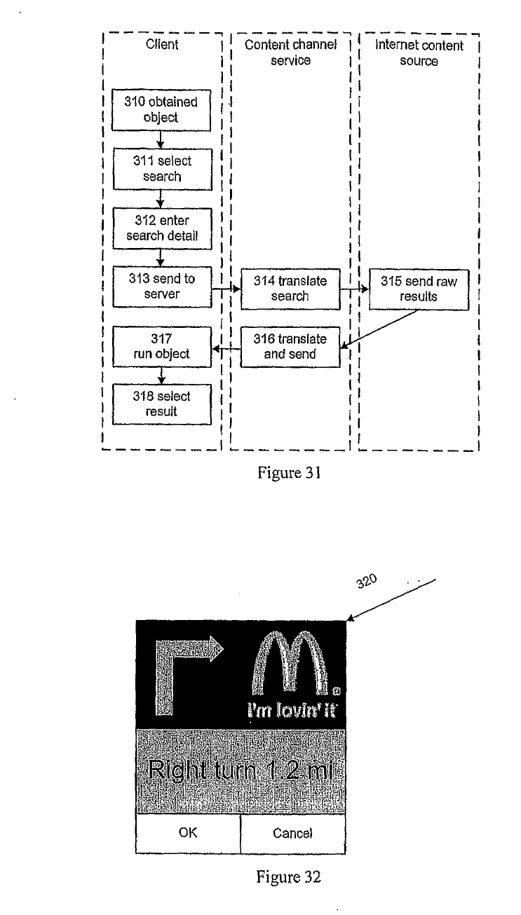

FIGS. 28, 29 and 30 show an example of the icon based menu framework used for Google Local searching in accordance with the present invention. FIG. 31 shows the steps performed by the system during a Google Local search. Initially in step it is assumed that steps 180 through 184 described with reference to FIG. 18 have been performed to obtain a plug-in object for the Google local channel. The Google Local icon 289 in FIG. 28 is selected at step 310 by the user to initiate a search in Google Local. The user then enters at step 311 a search term, in this case “gas station”, in the keyword field 291 shown in FIG. 29. In step 313 the search terms, together with the location of the navigation device are sent to a Google local content channel service at the server in accordance with step 262 described with reference to FIG. 26. In step 314, steps 263 and 264 described with reference to FIG. 26 are performed by the content channel proxy to reformat the search terms and location as an HTTP request to the Google Local server. The request is sent with the over the Internet, in the same way that any Google search request is made over the Internet from a web browser. The results assembled by Google Local are sent at step 315 back to the server as an HTML webpage in accordance with steps 265 and 266 described with reference to FIG. 26. In step 316 the webpage is converted by the content channel proxy on the server into a plug-in software object, and transmitted to the client device. The conversion process includes filtering based on the type of device on which the content is to be displayed and may include geocoding. If the navigation device can only display text, the object will only include text; if it can handle richer content then that may be included. The object might include the identity and location of a number of gas stations in the vicinity of the client device. The object is executed at step 317 by the client, generating a display of the search results in a number of formats, as a list similar to the list view 300 of FIG. 30, or on as radar display similar to the radar display 301 shown in FIG. 30. The user is then able to select at step 318 a gas station from the results list and a result detail screen similar to 302 in FIG. 30 is shown.

### Navigation Customisation Framework

Most navigation systems incorporating automatic route guidance generation deliver route guidance using a standard interface which is not dependent on the currently selected destination. In a further aspect of the present invention the navigation content provision framework can be extended using plug-in software objects, to deliver a different route guidance user interface to that normally used by the basic navigation platform. Route guidance to a special destination can be delivered by a custom user interface when a user of the client device requests guidance to the special destination. Preferably, the customised user interface is specific to the selected special destination and includes logos, colours, or other information associated with the special destination. Once the special destination has been reached, or an alternative destination selected, the user interface will no longer be specific to the destination.

In the manner just described the route guidance user interface can be customised to reflect themes, a brand and advertising related to a special destination in order to generate revenue for the location based service provider. Preferably, the special destination is a business, and the business pays a sponsorship fee to the provider of the route guidance information. FIG. 32 shows how the navigation device becomes an advertising platform for the sponsor, theming the route guidance to correspond with the sponsor's brand. If the sponsor's brand is associated with a particular colour that colour can be used as the predominant colour on screen. Similarly, a logo 320 can appear on screen and products on offer detailed. Almost any business model can be used to generate revenue from this system. Examples are the sponsor pays per navigate to, or a flat fee to the location based service provider and the sponsor makes a special offer to customers through the navigation device and pays the location based service provider when that offer is redeemed. Revenue generation in this manner is facilitated through a transaction reporting module of a content channel service.

The navigation route guidance customisation already mentioned for a special destination is provided in the form a plug-in object that executes on the client device. The plug-in object is associated with the special destination in a database of special destinations where user interface customisation is required. The client device has means to access this database, wherein, in use, when a user selects on the client device a destination for routing, the client device requests from the database whether the selected destination is a special destination, and, if the selected destination is a special destination, a corresponding plug-in software object, associated in the database with the destination, customises the route guidance user interface of the client device.

To implement the scheme, a point-of-interest (POI) database of business locations is required. The POI database contains information about the names, types and location of businesses. The POI database can be in any location accessible to the client device, including on the client device itself, on a server connected to the client device, or accessible on the Internet through a server connected to the Internet and the client device. The PO database can be a fixed database which is never updated, a database that is periodically updated, or a live database that is continuously updated. In a standalone system configuration such as is shown in FIG. 9 users can update a local POI database on a storage card by downloading an update periodically from the Internet using any means available. Example means are downloading a file from a website to a PC which is copied to the storage card using a storage card reader/writer connected to the PC.

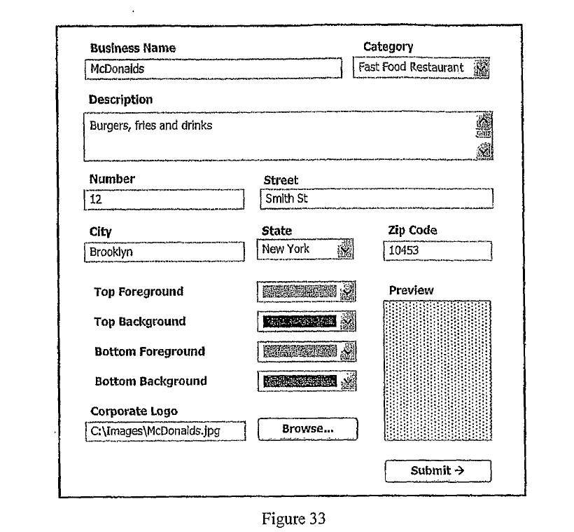

Preferably, the client device is connected to a server and the server contains a live database of special destinations which is maintained by a location based service provider or a third party. Preferably, in addition, content is added to the database when an advertising agreement is made with the location based service provider or third party, or by an individual business. Individual business can add their details to the database which is accessible via the Internet through an Internet web portal. Businesses that have subscribed to or wish to subscribe to, a sponsored guidance or destination specific advertising service can do so through the web portal. An example web portal user interface for a POI database is shown in FIG. 33. The web portal to the database allows for collection of theme information from businesses and allows businesses to mange their own requirements. The web portal is preferably simple to use and allows a business to enter its name, type and location and information used for advertising purposes. The advertising information determines how colour schemes are applied and may include small logos that are shown as part of the navigation content. A preview mode allows the advertiser to view the brand experience that end users will see in the navigation product as they drive to their selected destination.

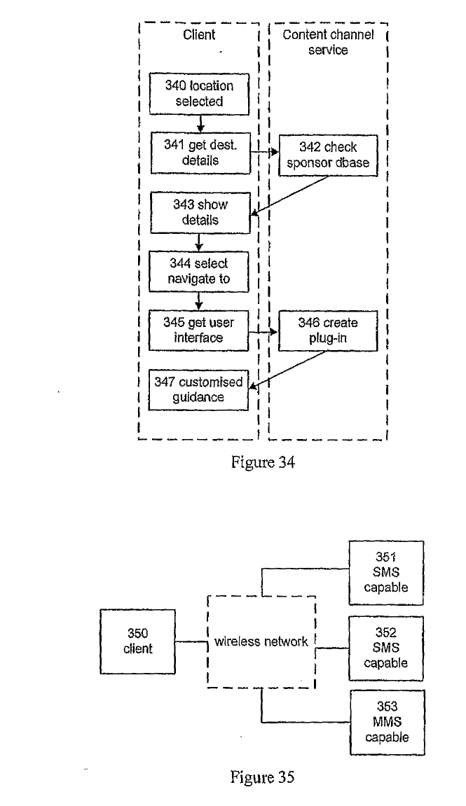

FIG. 32 shows an example of a user interface 320 that is specific to an intended destination, which in this example is a McDonalds fast food restaurant. FIG. 34 shows what happens in order to generate a custom navigation user interface when the McDonalds restaurant is used as a navigation destination. In step 340 a search for fast food restaurants is conducted and a particular restaurant from the list of results selected. The client device sends at step 341 a request for more details of the result to the content channel that provided the result. At step 342, the content channel checks its sponsored destination database and assembles a result detail object also containing a flag that the destination is a sponsored destination. The result details object is sent at step 343 to the navigation device where it is displayed. The result details object can generate a customised result detail display if necessary. For example, a special offer or advertising to further entice customers to navigate to the location could be shown. The user confirms 344 their selection and selects to navigate there. The client device sends at step 345 a request for a custom navigation user interface plug-in to the content channel service. The content channel service receives the plug-in and replies at step 346 with an object which can be used to generate the customised navigation user interface. The navigation device performs route guidance to the selected destination using the custom user interface in step 347. In this example, a McDonald's specific user interface is used, including a McDonald's logo 320 and colour scheme. Guidance instructions can be customised to mention McDonalds; for example, “McDonalds on the left in 1.5 mi”.

### Peer to Peer Messaging Framework

In a preferred embodiment a navigation content provision server can communicate wirelessly with one or a plural of connected navigation client devices. In addition, the navigation client devices have means to communicate across a wireless network with other navigation client devices or other devices of a different type. Example devices of a different type are cellular phones, PDAs, computers, or remote control devices. The network used to communicate between the navigation client device and other devices can be the same or a different network than is used by the navigation content provision server to communicate with the navigation client device. If the network does not support direct device to device communications then communications can also be via a sever such as a content channel server. Example networks that can be used for device to device communication are a cellular network, and an 802.11 LAN. The information can be sent between the devices by any messaging means supported by the navigation client and the second device. Examples are SMS, MMS, and email. In a preferred embodiment, the second device is a mobile phone, the wireless network used to communicate with other devices is cellular, and the information is sent as an SMS or MMS message.

The device to device communications network can be used by a navigation client device to send location based information to a second device via the wireless network. The information can be any information. Examples are details of a location, a map, route guidance to the location, and advertising. Preferably, the user of the navigation client specifies the location through the user interface of the client, and information dependent on the location is automatically generated and sent to a second device having means to connect to the wireless communications network. In this example, the navigation client device can send maps and instructions to any MMS enabled mobile phone, and text only instructions and information to any SMS enabled mobile phone. Furthermore, the information sent in either case can be viewed on an ordinary SMS or MMS capable phone, having no changes or special software. The navigation client device provides all the additional functionality required to generate and deliver location based information to any suitable phone.

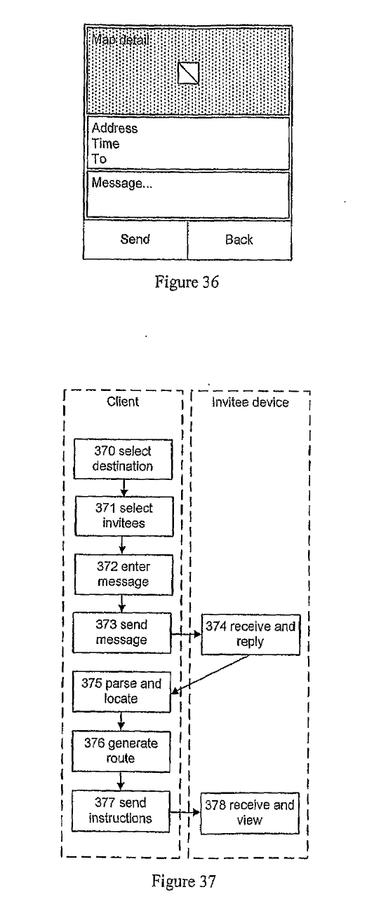

Navigation client software incorporating device to device messaging can be used to organise meetings between several participants who have at least a basic cellular phone capable of receiving SMS messages. FIG. 35 is a schematic illustration of a portable navigation device 350 acting in this manner for other portable wireless devices 351, and 352. In this example the meeting organizer sends invites to the meeting containing the location and other information as text messages. In a manner similar to this, meeting invitations can be sent from the navigation client device 350 as to the MMS capable phone 353 as an MMS message containing both text messages and images. FIG. 36 shows an example user interface used for sending messages. Once a location for the meeting has been selected and invitees selected, a meeting time can be chosen, and a brief message entered.

In a further aspect of the present invention a navigation client device having the means to send invitations wirelessly to other wireless devices, and means to generate navigation instructions can act as a navigation server to the other wireless devices. Continuing the example above and with reference to FIG. 35, routes for all invitees to the meeting who accept the invitation to participate in the meeting and who have provided a location, or whose location is known, can be generated on the organizer's navigation client device 350. Route guidance instructions can be sent as part of an acknowledgement message to participants as text only instructions to the SMS capable phones 351 and 352, and as multimedia instructions to the MMS capable mobile phone 353. The MMS phone 353 can receive a series of interactive graphical or audio turn instructions that can be browsed easily by a meeting participant using forward and backwards arrows. If location is not known for a participant then further details of the meeting including the time and place can be sent in a text only form to the SMS capable mobile phones 351 and 352, or as an MMS message containing the time and place along with a map of the destination and its surroundings.

There has been widespread adoption of cellular phones that provide standard features such as text messaging and multimedia messaging. Although it is slowly increasing, there is only limited adoption of client navigation devices or general purpose devices that run navigation client software. Preferably, in order to promote the awareness and proliferation of the location based products and services provided by a location based service provider, or to promote the products and services of third parties the messages sent by a navigation client device can also include advertising content. Preferably, the advertising content is delivered on behalf of a third party business by the location based service provider, and the business pays the location based service provider for delivery of the advertising. Any business model can be used. Examples are pay a flat fee to broadcast, pay per advertising message delivered, and revenue sharing of sales transactions generated through targeted special offers.

In accordance with the present invention the transmission of messages from device to device can be initiated or customised by plug-in objects. Furthermore, plug-in objects can be activated when messages are received in order to automatically process those messages or to automatically send further messages dependent on messages received. The basic navigation framework provides support for device to device messaging. This support is standardised in embodiments of the framework through the provision of Peer to Peer messaging APIs and a user interaction framework supporting inter device messaging. The plug-in objects supplied by content channels can use these mechanisms to achieve a variety of business aims for a location based service provider or a third party. Examples are simply creating awareness of a product or service, or driving traffic to a specific business location.

FIG. 37 illustrates what typically happens in the system when a user of a navigation client device organises a meeting with another person having an MMS capable mobile phone in accordance with the present invention. In step 370, the meeting organiser uses the navigation device to find a suitable meeting place using a destination search method such as the method already described with reference to FIG. 31. A plug-in object on the client device provides a user interface similar to that depicted in FIG. 36 that allows a meeting invitation to be constructed in step 371 for the other person containing the location of the meeting point. The location is typically described in the invitation in a human readable format, and the invitation may also contain a map image of the location. The invitation is sent in step 373 to the other person's mobile phone where it is received and viewed. Included in the invitation are instructions about how to accept or decline the meeting. Each participant can accept in step 374 the meeting request, as instructed in the original message, by replying (e.g. sending “Y”=yes or “N”=no), and may optionally specify their present location in the message reply (in a free format). If invitees have mobile phones for which location can be known through the network then the participant locations can be discovered automatically by the navigation client, in which case the present location need not be requested in the invitation. Usually in order for the meeting organiser to learn the location of other devices the owners of the other devices need to first indicate to the network that the meeting organiser has permission to know their current location. Example mobile phone networks enabling this capability at the present time in the United States are Sprint and Nextel. The acceptance message is received in step 375 by the organiser's client device. If available, the caller ID can be used to identify the sender. The location of the sender is determined in step 375, automatically through the network, by parsing the message, or is entered manually by the organiser. Once the location is known, in step 376 the navigation device uses that location to calculate route guidance instructions between the other person's location and the location of the meeting point. The instructions are sent in step 377 as an MMS messages containing turn instructions. The other person receives the message in step 378 and can then refer to the MMS instructions as they navigate to the meeting point. Along with the route guidance they see advertising for a product or service.

1. A navigation content provision framework comprising:
a client device having a basic navigation framework for providing basic navigation functionality, the basic navigation framework supporting a fixed set of plug-in software objects.

2. A content provision framework according to claim 1, further including a server, which is connected to the client device, and which is configured to provide plug-in software objects to the client device, the plug-in software objects providing additional functionality to the client device.

3. A content provision framework according to claim 2, wherein the client device and the server are connected via a wireless connection.

4. A content provision framework according to claim 2, wherein the client and server are located physically on the same device.

5. A method of providing additional functionality to a client device having a basic navigation framework for providing basic navigation functionality, the basic navigation framework supporting fixed set of plug-in software objects, comprising the step of:
providing plug-in software objects to the client device, the plug-in software objects providing additional functionality to the client device.

6. A method according to claim 5, wherein the step of providing plug-in software objects includes providing plug-in software objects from a server via a wireless connection.

7. A method according to claim 5, wherein the step of providing plug-in software objects includes embedding plug-in software objects within geographical data stored on the client device.

8. A method according to claim 5, wherein program code and data contained in the plug-in software objects is integrated with the program functionality of client software on the client device while the program code executes on the client device.

9. A method according to claim 5, wherein program code contained in the plug-in software objects is formatted in a portable byte code and is executed by a virtual machine contained on the client device.

10. A method of providing additional functionality to a client device having a basic navigation framework for providing basic navigation functionality, the basic navigation framework supporting fixed set of plug-in software objects, comprising the steps of:
providing plug-in software objects to the client device, and
storing the plug-in software objects temporarily or persistently on the client device, the plug-in software objects providing additional functionality to the client device when executed on the client device.

11. A method according to claim 10, wherein the step of providing plug-in software objects comprises providing only those objects which are not already persistently or temporarily stored in the client device.

12. A method according to claim 10, wherein the step of storing the plug-in software objects comprises storing the plug-in software objects on the client device until they are invalidated because the functionality or data they encapsulate has been withdrawn or updated.

13. A method according to claim 10, further comprising the step of deleting plug-in software objects from the client device to make room for more recently generated plug-in software objects.

14. A method according to claim 10, further including the step of registering the plug-in software objects with the client device to indicate conditions, which if they occur, cause the plug-in software objects to be deleted.

15. A navigation content provision framework comprising:
a server configured to provide plug-in software objects to client devices, the plug-in software objects providing additional functionality to the client devices when executed on the client devices.

16. A navigation content provision framework according to claim 15, wherein the server is configured to send details of available plug-ins to the client devices.

17. A navigation content provision framework comprising:
a client device having a basic navigation framework for providing basic navigation functionality, the basic navigation framework supporting fixed set of plug-in software objects;
an input device connected to or part of the client device, for providing an input signal in accordance with a property associated with the client device;
wherein the plug-in software objects are configured to execute on the client device in response to a signal from the input device.

18. A navigation content provision framework according to claim 17, wherein the input device is an absolute positioning means such as a GPS sensor.

19. A navigation content provision framework according to claim 17, wherein the input signal from the input device is related to the speed of the client device, the ambient temperature, ambient light levels, water depth, the time or specific forms of user input.

20. A navigation content provision framework according to claim 17, wherein the plug-in software objects are configured to register with the client device to specify relevant trigger signals and conditions.

21. A method of providing navigation functionality or navigation information to a user of a client device having a basic navigation framework for providing basic navigation functionality, the basic navigation framework supporting fixed set of plug-in software objects, comprising the step of:
providing plug-in software objects which are configured to execute on the client device in response to a specific condition associated with the client device.

22. A method according to claim 21, wherein the specific condition is related to the position of the client device.

23. A navigation content provision framework comprising:
a client device having a basic navigation framework for providing basic navigation functionality, the basic navigation framework supporting fixed set of plug-in software objects;
and a server in communication with the client device and the Internet;
wherein the client device includes means to send to the server a request for content, and wherein, the server includes means for requesting the content from sources connected to the Internet based on the request from the client device, means for receiving the resulting content and means for transmitting it to the client device in the form of a plug-in software object.

24. A navigation content provision framework according to claim 23, wherein the server is configured to provide a plug-in software object to the client device that, when executed on the client device, provides a means for a user to request content from the server.

25. A navigation content provision framework according to claim 23, wherein the client device includes a position determining system.

26. A navigation content provision framework according to claim 25, wherein a position of the client device as determined by the position determining system is sent with the request for content and the resulting content is tailored dependent on the position.

27. A navigation content provision framework according to claim 23, wherein the request for content is tailored dependent on a current travel itinerary, travel speed, time of day, date, or specific user defined preferences.

28. A navigation content provision framework according to claim 23, wherein the server is configured to provide plug-in software objects to the client device that provide additional functionality to the client device.

29. A method of displaying content from a content source on a client device having a display, comprising the steps of:
receiving a request for content from the client device at a remote navigation server;
sending the request from the navigation server to a server hosting the content on the Internet;
receiving the content at the navigation server;
reformatting content as a plug-in software object; and
sending the plug-in software object to the client device;
the plug-in software object being configured to execute on the client device to render information to the display of the client device.

30. A method according to claim 29, wherein an indication of the position of the client device is received with the request for content at the server.

31. A method according to claim 29, wherein the plug-in software object, when executed on the client device, is configured to generate a customized information display.

32. A method according to claim 29, wherein the client device further includes a map display and the plug-in software object, when executed on the client device, is configured alter the map display or annotate it with additional information.

33. A method according to claim 29, further including the step of sending a first plug-in software object to the client device from the server, the first plug-in software object, when executed on the client device, allowing content from the server to be requested.

34. A method according to claim 33, wherein, when executed, the first plug-in software object also generates a user interface to support user customization of the content request when this is required by an Internet content source.

35. A navigation content provision framework comprising:
a client device having a display; and
a server in communication with the client device and the Internet; and having means to access content sources on the Internet;
wherein the client device is configured such that, in use, icons representing favorite content requests are displayed on the display of the client device, and selection of an icon causes a predetermined content request to be sent to the Internet content source.

36. A navigation content provision framework according to claim 35, wherein the icons representing favorite content requests are integrated into an icon based menu of the client device.

37. A navigation content provision framework according to claim 35, wherein the Internet content source is a database, search engine, or remote sensor device.

38. A navigation content provision framework according to claim 35, wherein the content request is a search query or command.

39. A system for providing a navigation user interface on a client device comprising:
a client device having a display, a basic navigation framework for providing basic navigation functionality, the basic navigation framework supporting fixed set of plug-in software objects; and
a server in communication with the client device; having a destination database containing details of special destinations together with plug-in software objects specific to each special destination;
wherein, in use, when a user selects on the client device a destination for routing, the client device requests from the server whether the selected destination is in the destination database, and, if the selected destination is in the destination database, sends to the client a plug-in software object that adds functionality to the client device.

40. A method for providing a navigation user interface on a client device which is able to provide route guidance to specified destinations, comprising the steps of:
designating a destination as a special destination; and
when a user requests route guidance to that destination, providing a destination specific user interface on the client device.

41. A method according to claim 40, wherein the client device is connected to a central server containing a live special destination database, further comprising the step of querying the special destination database each time the a user requests route guidance to a destination.

42. A method according to claim 40, wherein the destination specific user interface is provided to the client device in the form of a software plug-in or plug-ins.

43. A method according to claim 40, wherein the special destination is a business.

44. A method according to claim 40, wherein the destination specific user interface includes a logo, colors or advertising associated with the destination.

45. A navigation content provision framework comprising:
a first device, having a basic navigation framework for providing basic navigation functionality, and means for connecting to a wireless communications network;
wherein the first device has a user interface that allows a user of the first to specify a location; and
wherein, in use, the first device sends automatically generated information dependent on the location to a remote device having means to connect to the wireless communications network.

46. A navigation content provision framework according to claim 45, wherein the automatically generated information is in the form of an SMS or MMS message.

47. A navigation content provision framework according to claim 45, wherein the first device is a client device in accordance with claim 1.

48. A navigation content provision framework according to claim 45, wherein the automatically generated information includes information about the specified location, or route guidance information indicating how to reach the specified location.

49. A navigation content provision framework according to claim 45, wherein the automatically generated information also contains advertising content for a business.

50. A method of providing navigation information to a device connected to a navigation content provision framework, the navigation content provision framework comprising a first device having a basic navigation framework for providing basic navigation functionality and means for connecting to a wireless communications network, the basic navigation framework supporting fixed set of plug-in software objects, and a server that can provide plug-in software objects to the first device, the plug-in software objects providing additional functionality to the first device when executed on the first device; comprising the steps of:
receiving a plug-in software object from the server at the first device;
allowing a user of the first device to specify a location; and
sending automatically customized information dependent on the location to a remote device having means to connect to the wireless communications network;
the plug-in software object being automatically executed on the first device, allowing the information sent to the remote device to be customized.

51. A method according to claim 50, wherein the automatically generated information is in the form of an SMS or MMS message.

52. A method according to claim 50, wherein the first device is a client device in accordance with claim 1.

53. A method according to claim 50, wherein the automatically generated information includes information about the specified location, or route guidance information indicating how to reach the specified location.

54. A method according to claim 50, wherein the automatically generated information also contains advertising content for a business.
